(19) United States
(12) Patent Application Publication
(10) Pub. No.: US 2010/0227084 A1
(43) Pub. Date: Sep. 9, 2010

(54) LIQUID CRYSTAL COMPOSITION AND REFLECTIVE DISPLAY ELEMENT

(76) Inventors: Takashi KATO, Kanagawa (JP); Naoyuki Hayashi, Kanagawa (JP)

Correspondence Address: BIRCH STEWART KOLASCH & BIRCH, PO BOX 747, FALLS CHURCH, VA, 22040-0747, US

(21) Appl. No.: 12/715,462

(22) Filed: Mar. 2, 2010

(30) Foreign Application Priority Data
Mar. 4, 2009 (JP) 2009-050937

(51) Int. Cl. C09K 19/52; C09K 19/00

(52) U.S. Cl. 428/1.1; 252/299.01

(57) ABSTRACT

A liquid crystal composition includes a dichroic dye represented by Formula (1) below, a nematic liquid crystal and at least two chiral reagents. R¹ to R⁸ each independently represent a hydrogen atom or a substituent, in which at least one of R¹ to R⁸ represents a substituent represented by -(Het)ₘ-{(B¹)ₚ-(Q¹)_{q}-(B²)ᵣ}ₙ—C¹. A reflective display element electrodes at least one of which is a transparent electrode, and a liquid crystal layer placed between the pair of electrodes and containing the liquid crystal composition.

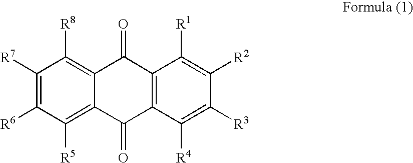

### CROSS REFERENCE TO RELATED APPLICATIONS

This application claims priority under 35USC 119 from Japanese Patent Application No. 2009-050937, filed on Mar. 4, 2009, the disclosure of which is incorporated herein by reference.

### BACKGROUND OF THE INVENTION

1. Field of the Invention

The present invention relates to a liquid crystal composition and a reflective display element having a liquid crystal layer including the liquid crystal composition, and particularly to a liquid crystal composition and a reflective display element in a guest-host (referred to sometimes as “GH”) system.

2. Description of the Related Art

With the spread of the digital technology, the importance of a paper type display for displaying digital information (hereinafter referred to as “electronic paper”) has been increasing. Many systems have been proposed so far for the electronic paper. Examples include a reflection type liquid crystal display system, electrophoresis display system, magnetophoresis display system, dichroic ball rotation system, electrochromic display system, and leucothermal system.

The performance required for the electronic paper includes a high visual recognition and low electric power consumption. High visual recognition means white background similar to paper, and hence a display method based on light-scattering white background similar to paper is suited. On the other hand, as to the electric power consumption, the reflection type display system is excellent as compared with the self light-emission display system.

Various modes of liquid crystal elements (liquid crystal display elements) have been proposed. In particular, a guest-host mode liquid crystal element enables bright display and, therefore, shows promise as a reflective liquid crystal element. In a guest-host mode liquid crystal element, a liquid crystal composition, which is a solution of a dichroic dye in a nematic liquid crystal, is sealed in a cell, to which an electric field is applied to change the alignment of the dichroic dye according to the movement of the liquid crystal under the electric field, so that the absorption of light of the cell is changed to effect display.

In contrast to other conventional liquid crystal display modes, the guest-host mode liquid crystal element makes it possible to achieve a polarizing plate-free driving mode and, therefore, shows promise as a reflective display element that can provide brighter display.

Dichroic dyes for use in guest-host mode liquid crystal elements are required to have appropriate absorption properties, a high order parameter, high solubility in the host liquid crystal, durability, and other properties.

The order parameter S may be defined by S=(3 cos² θ−1)/2, when the long molecular axes of the thermally fluctuating molecules are tilted by a time-averaged angle of θ with respect to the director. When S=0.0, the molecules do not have any order at all. When S=1.0, the long molecular axes are aligned with the direction of the director.

A very small number of conventional dichroic dyes provide a sufficiently high order parameter, which leads to a reduction in the display contrast of guest-host mode liquid crystal display elements. Japanese Patent Application Laid-Open (JP-A) Nos. 62-64886, 02-178390 and 10-260386 disclose that among dichroic dyes, some azo dyes and anthraquinone dyes can provide a relatively high order parameter.

### SUMMARY OF THE INVENTION

A first embodiment of the invention is directed to a liquid crystal composition including at least one dichroic dye represented by Formula (1) below, at least one nematic liquid crystal, and at least two chiral reagents.

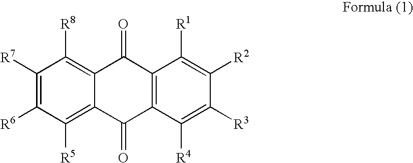

In Formula (1), R¹, R², R³, R⁴, R⁵, R⁶, R⁷, and R⁸ each independently represent a hydrogen atom or a substituent, and in which at least one of R¹, R², R³, R⁴, R⁵, R⁶, R⁷, and R⁸ represents a substituent represented by -(Het)ₘ-{(B¹)ₚ-(Q¹)_{q}-(B²)ᵣ}ⁿ—C¹, in which: Het represents an oxygen atom, a sulfur atom or NR, in which R represents a hydrogen atom, an alkyl group, an aryl group, or a heteroaryl group; B¹ and B² each independently represent an arylene group, a heteroarylene group or a divalent cyclic aliphatic hydrocarbon group; Q¹ represents a divalent linking group; C¹ represents an alkyl group, a cycloalkyl group, an alkoxy group, an acyl group, an alkoxycarbonyl group, or an acyloxy group; m represents 0 or 1; p, q and r each represent an integer from 0 to 5; n represents an integer from 1 to 3; (p+r)n is from 3 to 10; when p, q and r are each 2 or more, two or more occurrences of B¹, Q¹ or B² may represent the same or different species; and when n is 2 or more, two or more occurrences of {(B¹)ₚ-(Q¹)_{q}-(B²)ᵣ} may represent the same or different species.

A second embodiment of the invention is directed to a reflective display element including a pair of electrodes at least one of which is a transparent electrode, and a liquid crystal layer placed between the pair of electrodes and containing the liquid crystal composition of the first embodiment.

### BRIEF DESCRIPTION OF THE DRAWINGS

FIG. 1 is a schematic cross-sectional view showing an example of the reflective display element of the invention;

FIG. 2 is a schematic cross-sectional view showing another example of the reflective display element of the invention; and

FIG. 3 is a schematic cross-sectional view showing a further example of the reflective display element of the invention.

### DETAILED DESCRIPTION OF THE INVENTION

Conventional dichroic dyes as described above have low solubility in host liquid crystals, particularly in fluorine-containing liquid crystals, which have been frequently used in recent years, and therefore cannot provide sufficiently high optical density, when used in liquid crystal display elements. Some conventional dichroic dyes have low response speed, and the improvement has been expected.

In view of the above circumstances, the inventors have made investigations. As a result, the inventors have found that when a dichroic dye having a specific substituent at a specific position is used in combination with different plural types of chiral reagents, a reflective display element that provides very high display performance and high response speed can be achieved. As a result of further investigations based on the finding, the present invention has been completed.

Hereinafter, the present invention will be described in detail. The denotation “to” in this specification means the numerals before and after “to”, both inclusive as the minimum value and the maximum value, respectively.

In the present invention, the liquid crystal composition and the reflective display element each include at least one dichroic dye represented by Formula (1) below, at least one nematic liquid crystal, and at least two chiral reagents.

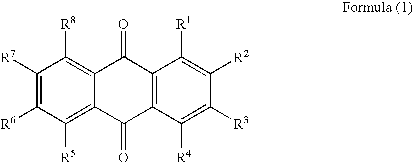

In Formula (1), R¹, R², R³, R⁴, R⁵, R⁶, R⁷, and R⁸ each independently represent a hydrogen atom or a substituent, and in which at least one of R′, R², R³, R⁴, R⁵, R⁶, R⁷, and R⁸ represents a substituent represented by -(Het)ₘ-{(B¹)ₚ-(Q¹)_{q}-(B²)ᵣ}ₙ—C¹, in which: Het represents an oxygen atom, a sulfur atom or NR, in which R represents a hydrogen atom, an alkyl group, an aryl group, or a heteroaryl group; B¹ and B² each independently represent an arylene group, a heteroarylene group or a divalent cyclic aliphatic hydrocarbon group; Q¹ represents a divalent linking group; C¹ represents an alkyl group, a cycloalkyl group, an alkoxy group, an acyl group, an alkoxycarbonyl group, or an acyloxy group; m represents 0 or 1; p, q and r each represent an integer from 0 to 5; n represents an integer from 1 to 3; (p+r)n is from 3 to 10; when p, q and r are each 2 or more, two or more occurrences of B¹ , Q¹ or B² may represent the same or different species; and when n is 2 or more, two or more occurrences of {(B₁)ₚ-(Q¹)_{q}-(B²)ᵣ} may represent the same or different species.

The reflective display element of the present invention may include a combination of a liquid crystal layer capable of electrically controlling optical transmission and a reflecting layer capable of reflecting light. The alignment state of the host liquid crystal in the liquid crystal layer is electrically changed so that the liquid crystal layer is turned into a colored state or a transparent state, which makes it possible to control the colored state and the white state.

Particularly, in the reflective display element of the present invention, the dichroic dye represented by Formula (1) is used in combination with different plural types of chiral reagents, so that the amount of light absorption in the colored state well differs from that in the white state. Therefore, when the host liquid crystal is aligned horizontally to surface of the support, high color development is achieved, and when the host liquid crystal is aligned vertically to the surface of the support, the light transmittance becomes high to increase the whiteness, which leads to high display performance. This phenomenon is described in detail below.

It has also been found that the reflective display element of the present invention including a combination of the dichroic dye represented by Formula (1) and the different plural types of chiral reagents has the unexpected advantage that a high response speed is achieved. This phenomenon is also described in detail below.

The reflective display element of the present invention includes at least one liquid crystal layer containing the dichroic dye represented by Formula (1), a host liquid crystal, and different plural types of chiral reagents. In the description, the composition to compose the liquid crystal layer is referred to as “liquid crystal composition,” which includes at least the dichroic dye, a host liquid crystal and different plural types of chiral reagents and may further include any other additive.

<Liquid Crystal Layer>

### (Dichroic Dye)

In the light modulating material of the present invention, the dichroic dye is defined as a compound which is dissolved in a host liquid crystal and has a function of absorbing light. While the absorption maximum and the absorbing band of the dichroic dye are not particularly restricted, it is preferred that the dye has an absorption maximum in a yellow region (Y), a magenta region (M) or a cyan region (C). Moreover, two or more kinds of dichroic dyes may be used, and it is preferable to use the mixture of dichroic dyes which have the maximum absorption in Y, M, and C. As for the method of carrying out the full-color display by mixing the yellow dye, the magenta dye, and the cyan dye, the detail is described in “Color Chemistry” (written by Sumio Tokita, Maruzen, 1982). Here, the yellow region means in a range of 430 to 490 nm, the magenta region in a range of 500 to 580 nm, and the cyan region in a range of 600 to 700 nm.

In an embodiment of the present invention, an anthraquinone compound represented by Formula (1) is used as the dichroic dye. In general, it is known that the addition of a dichroic dye to a chiral reagent-containing liquid crystal composition increases the viscosity, so that the response speed is reduced. It is thought that this is because the dichroic dye interacts with the chiral reagent and the liquid crystal. However, it is thought that when the dichroic dye has an anthraquinone structure, this interaction becomes small, and an increase in the viscosity is suppressed, so that a reduction in the response speed is also suppressed. In addition, when the dichroic dye is used in combination with different plural types of chiral reagents, the interaction between the dichroic dye and each chiral reagent can be reduced to a very low level, so that high display contrast and high response speed can be achieved.

In addition, the dichroic dye having an anthraquinone structure is prevented from being decomposed by light, heat and water, when used in the reflective display material. Particularly in this case, degradation products, which have an electrically adverse effect and therefore are serious for the reflective display material, are not produced, so that high durability against light, heat and water is provided. In particular, durability against light is improved.

The dichroic dye represented by Formula (1) is described in detail below.

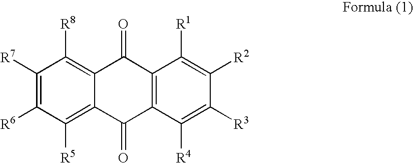

In Formula (1), R¹, R², R³, R⁴, R⁵, R⁶, R⁷, and R⁸ each independently represent a hydrogen atom or a substituent, and in which at least one of R¹, R², R³, R⁴, R⁵, R⁶, R⁷, and R⁸ represents a substituent represented by -(Het)ₘ-{(B¹)ₚ-(Q¹)₁-(B²)ᵣ}ₙ—C¹.

When a dichroic dye represented by Formula (1) in which at least one of R¹, R², R³, R⁴, R⁵, R⁶, R⁷, and R⁸ is a substituent represented by -(Het)ₘ-{(B¹)ₚ-(Q¹)_{q}-(B²)ᵣ)}ₙ—C¹ is used in the reflective display material, high display contrast and high response speed are achieved. The reason for this can be considered to be as described below, but the effect described below is not intended to limit the scope of the present invention.

The dichroic dye in which at least one of R¹, R², R³, R⁴, R⁵, R⁶, R⁷ and R⁸ is a substituent represented by -(Het)ₘ-{(B¹)ₚ-(Q¹)_{q}-(B²)ᵣ}ₙ—C¹ has a structure with an introduced rod-like substituent and therefore is characterized by having a high degree of order and high solubility in the host liquid crystal. Particularly when R¹, R⁴, R⁵, or R⁸ is a substituent represented by -(Het)ₘ-{(B¹)ₚ-(Q¹)_{q}-(B²)ᵣ}ₙ—C¹, m is 1 and Het is a sulfur atom or NR, the dichroic dye has a structure in which the introduced rod-like substituent is oriented in the direction of the long molecular axis, and therefore is characterized by having a particularly high degree of order and particularly high solubility in the host liquid crystal.

The use of the dichroic dye according to the present invention in the reflective display material is also effective in increasing durability against light, heat and water. The reason for this can be considered to be as described below.

The dichroic dye represented by Formula (1) has a high degree of order and high solubility in the host liquid crystal. Therefore, it is thought that the dye molecule and the host liquid crystal are present in such a manner that they are densely dissolved together at a molecular level. Thus, it is thought that infiltration of oxygen and water molecules is suppressed so that the dichroic dye is less likely to be decomposed, which may lead to an increase in durability against light, heat and water.

As described above, the dichroic dye represented by Formula (1) is thought to increase the display density, because of its high solubility in the host liquid crystal. It is also considered that the dichroic dye can increase the light transmittance when vertically aligned, because of its high order in the host liquid crystal. As a result, this dichroic dye may lead to high display contrast. It is also considered that the dichroic dye represented by Formula (1) can more strongly interact with the host liquid crystal than with the chiral reagent, so that it can suppress an increase in the viscosity of the liquid crystal composition containing the chiral reagents and the dichroic dye, which may increase the response speed.

Preferably at least one of R¹, R⁴, R⁵, and R⁸, more preferably at least one of R¹ and R⁵ is a substituent represented by -(Het)ₘ-{(B¹)ₚ-(Q¹)_{q}-(B²)ᵣ}ₙ—C¹.

Particularly when at least R¹ is a substituent represented by -(Het)ₘ-{(B¹)ₚ-(Q¹)_{q}-(B²)ᵣ}ₙ—C¹, the dichroic dye has a high degree of order and high solubility in the host liquid crystal, so that it can improve the display contrast. In addition, it can also suppress an increase in the viscosity of the chiral reagent-containing host liquid crystal material, so that it can improve the response speed performance.

The compound represented by Formula (1) may have any substituents represented by -(Het)ₘ-{(B¹)ₚ-(Q¹)_{q}-(B²)ᵣ}ₙ—C¹. The compound represented by Formula (1) is preferably a mono-substituted compound having one substituent, a di-substituted compound having two substituents, tri-substituted compound having three substituents, or tetra-substituted compound having four substituents, more preferably a di- or tri-substituted compound. A di-substituted compound is more preferred, because it has a higher degree of order and higher solubility in the host liquid crystal.

When the compound represented by Formula (1) is a di-substituted compound, R¹ and R⁵ each preferably represent the substituent ((Het)ₘ-{(B¹)ₚ-(Q¹)_{q}-(B²)ᵣ}ₙ—C¹), because such a combination of the substituents can provide a higher degree of order in the host liquid crystal, or R¹ and R⁴ each preferably represent the substituent, because such a combination of the substituents can provide higher solubility in the host liquid crystal.

When the compound represented by Formula (1) is a tri-substituted compound, R¹, R⁴ and R⁵ each preferably represent the substituent represented by -(Het)ₘ-{(B¹)ₚ-(Q¹)_{q}-(B²)ᵣ}ₙ—C¹.

When the compound represented by Formula (1) is a tetra-substituted compound, R¹, R⁴, R⁵, and R⁸ each preferably represent the substituent represented by -(Het)ₘ-{(B¹)ₚ-(Q¹)_{q}-(B²)ᵣ}ₙ—C¹.

In Formula (1), Het represents an oxygen atom, a sulfur atom or NR, in which R represents a hydrogen atom, an alkyl group, an aryl group, or a heteroaryl group.

Het preferably represents a sulfur atom or NR, particularly preferably a sulfur atom. Examples of the alkyl, aryl or heteroaryl group represented by R include those of the alkyl, aryl or heteroaryl group described below in the section “Substituent Group V.” R preferably represents a hydrogen atom or an alkyl group, more preferably a hydrogen atom.

B¹ and B² each independently represent an arylene group, a heteroarylene group, or a bivalent cyclic aliphatic hydrocarbon group.

The arylene group represented by B¹ and B² is preferably an arylene group having 6 to 20 carbon atoms. Specific examples of preferred arylene group include, for example, a bivalent group of a benzene ring, naphthalene ring and anthracene ring. In particular, a bivalent group of a benzene ring or a substituted benzene ring is preferable, and further preferably 1,4-phenylene group.

The heteroarylene group represented by B¹ and B² is preferably an heteroarylene group having 1 to 20 carbon atoms. Specific examples of preferred heteroarylene group include, for example, a bivalent heteroarylene group including pyridine ring, quinoline ring, isoquinoline ring, pyrimidine ring, pyrazine ring, thiophene ring, furan ring, oxazole ring, thiazole ring, imidazole ring, pyrazole ring, oxadiazole ring, thiadiazole ring, and triazole ring, as well as a bivalent heteroarylene group which is a condensed ring formed by ring condensation thereof.

Specific examples of preferred bivalent cycloaliphatic hydrocarbon group represented by B¹ and B² include cyclohexane-1,2-diyl, cyclohexane-1,3-diyl, cyclohexane-1,4-diyl, and cyclopentane-1,3-diyl; particularly preferably (E)-cyclohexane-1,4-diyl.

An arylene group, a heteroarylene group, and a bivalent cyclic aliphatic hydrocarbon group represented by B¹ and B² may further have a substituent, and the substituent includes the following substituent group V.

(Substituent Group V)

Halogen atoms (e.g. chlorine, bromine, iodine, and fluorine), mercapto groups, cyano groups, carboxy groups, phosphoric acid groups, sulfo groups hydroxy groups, carbamoyl groups having 1 to 10 carbon atoms, preferably 2 to 8 carbon atoms, and even more preferably 2 to 5 carbon atoms (e.g. methylcarbamoyl, ethylcarbamoyl, and morpholinocarbamoyl), sulfamoyl groups having 0 to 10 carbon atoms, preferably 2 to 8 carbon atoms, and even more preferably 2 to 5 carbon atoms (e.g. methylsulfamoyl, ethylsulfamoyl, and piperidinosulfamoyl), nitro groups, alkoxy groups having 1 to 20 carbon atoms, preferably 1 to 10 carbon atoms, and even more preferably 1 to 8 carbon atoms (e.g. methoxy, ethoxy, 2-methoxyethoxy, and 2-phenylethoxy), aryloxy groups having 6 to 20 carbon atoms, preferably 6 to 12 carbon atoms, and even more preferably 6 to 10 carbon atoms (e.g. phenoxy, p-methylphenoxy, p-chlorophenoxy, and naphthoxy), acyl groups having 1 to 20 carbon atoms, preferably 2 to 12 carbon atoms, and even more preferably 2 to 8 carbon atoms (e.g. acetyl, benzoyl, and trichloroacetyl), acyloxy groups having 1 to 20 carbon atoms, preferably 2 to 12 carbon atoms, and even more preferably 2 to 8 carbon atoms (e.g. acetyloxy and benzoyloxy), acylamino groups having 1 to 20 carbon atoms, preferably 2 to 12 carbon atoms, and even more preferably 2 to 8 carbon atoms (e.g. acetylamino), sulfonyl groups having 1 to 20 carbon atoms, preferably 1 to 10 carbon atoms, and even more preferably 1 to 8 carbon atoms (e.g. methanesulfonyl, ethanesulfonyl and benzenesulfonyl), sulfinyl groups having 1 to 20 carbon atoms, preferably 1 to 10 carbon atoms, and even more preferably 1 to 8 carbon atoms (e.g. methanesulfinyl, ethanesulfinyl, and benzenesulfinyl), sulfonyl amino groups having 1 to 20 carbon atoms, preferably 1 to 10 carbon atoms, and even more preferably 1 to 8 carbon atoms (e.g. methanesulfonyl amino, ethanesulfonyl amino, and benzenesulfonyl amino),

substituted or unsubstituted amino groups having 0 to 20 carbon atoms, preferably 0 to 12 carbon atoms, and even more preferably 0 to 8 carbon atoms (e.g. an unsubstituted amino group, methylamino, dimethylamino, benzylamino, anilino, diphenylamino), ammonium groups having 0 to 15 carbon atoms, preferably 3 to 10 carbon atoms, and even more preferably 3 to 6 carbon atoms (e.g. trimethylammonium and triethylammonium), hydrazino groups having 0 to 15 carbon atoms, preferably 1 to 10 carbon atoms, and even more preferably 1 to 6 carbon atoms (e.g. trimethylhydrazino group), ureido groups having 1 to 15 carbon atoms, preferably 1 to 10 carbon atoms, and even more preferably 1 to 6 carbon atoms (e.g. ureido group and N,N-dimethylureido group), imido groups having 1 to 15 carbon atoms, preferably 1 to 10 carbon atoms, and even more preferably 1 to 6 carbon atoms (e.g. succiminido group), alkylthio groups having 1 to 20 carbon atoms, preferably 1 to 12 carbon atoms, and even more preferably 1 to 8 carbon atoms (e.g. methylthio, ethylthio, and propylthio), arylthio groups having 6 to 80 carbon atoms, preferably 6 to 40 carbon atoms, and even more preferably 6 to 30 carbon atoms (e.g. phenylthio, p-methylphenylthio, p-chlorophenylthio, 2-pyridylthio, 1-naphthylthio, 2-naphthylthio, 4-propylcyclohexyl-4′-diphenylthio, 4-butylcylcohexyl-4′-biphenylthio, 4-pencylcyclohexyl-4′-biphenylthio, 4-propylphenyl-2-ethinyl-4′-biphenylthio), heteroarylthio groups having 1 to 80 carbon atoms, preferably 1 to 40 carbon atoms, and even more preferably 1 to 30 carbon atoms (e.g. 2-pyridylthio, 3-pyridylthio, 4-pyridylthio, 2-quinolylthio, 2-furylthio, and 2-pyrrolylthio),

alkoxycarbonyl groups having 2 to 20 carbon atoms, preferably 2 to 12 carbon atoms, and even more preferably 2 to 8 carbon atoms (e.g. methoxycarbonyl, ethoxycarbonyl, and 2-benzyloxycarbonyl), aryloxycarbonyl groups having 6 to 20 carbon atoms, preferably 6 to 12 carbon atoms, and even more preferably 6 to 10 carbon atoms (e.g. phenoxycarbonyl), unsubstituted alkyl groups having 1 to 18 carbon atoms, preferably 1 to 10 carbon atoms, and even more preferably 1 to 5 carbon atoms (e.g. methyl, ethyl, propyl, and butyl), substituted alkyl groups having 1 to 18 carbon atoms, preferably 1 to 10 carbon atoms, and even more preferably 1 to 5 carbon atoms {e.g. hydroxymethyl, trifluoromethyl, benzyl, carboxyethyl, ethoxycarbonylmethyl, and acethylaminomethyl, and herein unsaturated hydrocarbon groups having 2 to 18 carbon atoms, preferably 3 to 10 carbon atoms, and even more preferably 3 to 5 carbon atoms (e.g. vinyl, ethinyl, 1-cyclohexenyl, benzylidinyl, and benzylidenyl) are also included in the substituted alkyl groups}, substituted or unsubstituted aryl groups having 6 to 20 carbon atoms, preferably 6 to 15 carbon atoms, and even more preferably 6 to 10 carbon atoms (e.g. phenyl, naphthyl, p-carboxyphenyl, p-nitrophenyl, 3,5-dichlorophenyl, p-cyanophenyl, m-fluorophenyl, p-tolyl, 4-propylcyclohexyl-4′-biphenyl, 4-butylcyclohexyl-4′-biphenyl, 4-pentylcyclohexyl-4′-biphenyl, and 4-propylphenyl-2-ethinyl-4′-biphenyl), substituted or unsubstituted hetero ring groups having 1 to 20 carbon atoms, preferably 2 to 10 carbon atoms, and even more preferably 4 to 6 carbon atoms (e.g. pyridyl, 5-methylpyridyl, thienyl, furyl, morpholino, and tetrahydrofurfuryl), and substituted or unsubstituted heteroaryloxy (e.g. 3-thienyloxy).

These substituent group V may have a condensed structure of benzene rings or naphthalene groups and these substituents may be substituted with the above exemplified substituent group V.

Preferred examples of the substituent from the substituent group V include a hydroxy group, an arylthio group having 6 to 80 carbon atoms, more preferably 6 to 40 carbon atoms, and even more preferably 6 to 30 carbon atoms (e.g., phenylthio, p-methylphenylthio, p-chlorophenylthio, 4-methylphenylthio, 4-ethylphenylthio, 4-n-propylphenylthio, 2-n-butylphenylthio, 3-n-butylphenylthio, 4-n-butylphenylthio, 2-tert-butylphenylthio, 3-tert-butylphenylthio, 4-tert-butylphenylthio, 3-n-pentylphenylthio, 4-n-pentylphenylthio, 4-amylpentylphenylthio, 4-hexylphenylthio, 4-heptylphenylthio, 4-octylphenylthio, 4-trifluoromethylphenylthio, 3-trifluoromethylphenylthio, 2-pyridylthio, 1-naphthylthio, 2-naphthylthio, 4-propylcyclohexyl-4′-biphenylthio, 4-butylcyclohexyl-4′-biphenylthio, 4-pentylcyclohexyl-4′-biphenylthio, 4-propylphenyl-2-ethynyl-4′-biphenylthio), a heteroarylthio group having 1 to 80 carbon atoms, more preferably 1 to 40 carbon atoms, and even more preferably 1 to 30 carbon atoms (e.g., 2-pyridylthio, 3-pyridylthio, 4-pyridylthio, 2-quinolylthio, 2-furylthio, 2-pyrrolylthio), a substituted or unsubstituted alkylthio group (e.g., methylthio, ethylthio, butylthio, phenethylthio), a substituted or unsubstituted amino group (e.g., amino, methylamino, dimethylamino, benzylamino, anilino, diphenylamino, 4-methylphenylamino, 4-ethylphenylamino, 3-n-propylphenylamino, 4-n-propylphenylamino, 3-n-butylphenylamino, 4-n-butylphenylamino, 3-n-pentylphenylamino, 4-n-pentylphenylamino, 3-trifluoromethylphenylamino, 4-trifluoromethylphenylamino, 2-pyridylamino, 3-pyridylamino, 2-thiazolylamino, 2-oxazolylamino, N,N-methylphenylamino, N,N-ethylphenylamino), a halogen atom (e.g., a fluorine atom, a chlorine atom), a substituted or unsubstituted alkyl group (e.g., methyl, trifluoromethyl), a substituted or unsubstituted alkoxy group (e.g., methoxy, trifluoromethoxy), a substituted or unsubstituted aryl group (e.g., phenyl), a substituted or unsubstituted heteroaryl group (e.g., 2-pyridyl), a substituted or unsubstituted aryloxy group (e.g., phenoxy), and a substituted or unsubstituted heteroaryloxy group (e.g., 3-thienyloxy).

The substituent from the substituent group V is more preferably the alkyl group, the aryl group, the alkoxy group, the aryloxy group, the halogen atom, the unsubstituted amino group, the substituted amino group, the hydroxy group, the alkylthio group, or the arylthio group, even more preferably the oxygen, sulfur or nitrogen atom-containing group such as the hydroxy group, the alkoxy group, the aryloxy group, the alkylthio group, the arylthio group, the unsubstituted amino group, or the substituted amino group (the alkylamino group, the arylamino group), in particular preferably the hydroxy group.

Q¹ represents a bivalent linking group. Preferable is a linking group which consists of the atomic group composed of at least one atom selected from the carbon atom, the nitrogen atom, the sulfur atom, and the oxygen atom.

The bivalent linking group represented by Q¹ preferably includes bivalent linking groups comprising an alkylene group having preferably 1 to 20 carbon atoms (for example, methylene, ethylene, propylene, butylenes, pentylene, cyclohexyl-1,4-diyl), an alkenylene group having preferably 2 to 20 carbon atoms (for example, ethenylene), an alkynylene groups having preferably 2 to 20 carbon atoms (for example, ethynylene), an amide group, an ether group, an ester group, a sulfoamide group, a sulfonate group, an ureido group, a sulfonyl group, a sulfinyl group, a thioether group, a carbonyl group, an —NR— group (herein, R represents hydrogen atom, an alkyl group, or an aryl group.), an azo group, an azoxy group, and a bivalent heterocyclic group (for example, piperazine-1,4-diyl) or a bivalent linking group having 0 to 60 carbon atoms composed by the combination of two or more of them.

As a bivalent linking group represented by Q¹, an alkylene group, an alkenylene group, an alkynylene group, an ether group, a thioether group, an amide group, an ester group, a carbonyl group, and a bivalent linking group composed by the combination of two or more of them are preferable.

Q¹ may further have a substituent, and the substituent group V is enumerated as the substituent.

C¹ represents an alkyl group, a cycloalkyl group, an alkoxy group, an acyl group, an alkoxycarbonyl group, or an acyloxy group.

C¹ preferably represents an alkyl and a cycloalkyl group having 1 to 30 carbon atoms, more preferably 1 to 12 carbon atoms, and further preferably 1 to 8 carbon atoms (for example, methyl, ethyl, propyl, butyl, t-butyl, i-butyl, s-butyl, pentyl, t-pentyl, hexyl, heptyl, octyl, cyclohexyl, 4-methylcyclohexyl, 4-ethylcyclohexyl, 4-propylcyclohexyl, 4-butylcyclohexyl, 4-pentylcyclohexyl, hydroxymethyl, trifluoromethyl, benzyl), an alkoxy group having 1 to 20 carbon atoms, more preferably 1 to 10 carbon atoms, and further preferably 1 to 8 carbon atoms (for example, methoxy, ethoxy, 2-methoxyethoxy, 2-phenylethoxy), an acyl group having 1 to 20 carbon atoms, more preferably 1 to 12 carbon atoms, and further preferably 2 to 8 carbon atoms (for example, acetyl, pivaloyl, formyl), an acyloxy group having 1 to 20 carbon atoms, more preferably 2 to 12 carbon atoms, and further preferably 2 to 8 carbon atoms (for example, acetyloxy, benzoyloxy),or an alkoxycarbonyl group having 2 to 20 carbon atoms, more preferably 2 to 12 carbon atoms, and further preferably 2 to 8 carbon atoms (for example, methoxycarbonyl, ethoxycarbonyl, 2-benzyloxycarbonyl).

In particular, C¹ preferably represents an alky group or an alkoxy group, and more preferably ethyl, propyl, butyl, pentyl, hexyl or trifluoromethoxy.

The alkyl group, the cycloalkyl group, the alkoxy group, the acyl group, the alkoxycarbonyl group or the acyloxy group represented by C¹ may further have a substituent, and the substituent group V is enumerated as the substituent.

m represents 0 or 1, and preferably 0.

p, q and r each independently represents an integer from 0 to 5, and n represents an integer from 1 to 3. (p+r)×n is an integer from 3 to 10. In a case where p, q, or r is 2 or greater, two or more repeating unit thereof may be identical or different with each other respectively. Preferable combinations of p, q, r, and n will be described as follows.

(1) p=3, q=0, r=0, n=1

(2) p=4, q=0, r=0, n=1

(3) p=5, q=0, r=0, n=1

(4) p=2, q=1, r=1, n=1

(5) p=1, q=1, r=2, n=1

(6) p=3, q=1, t=1, n=1

(7) p=1, q=1, r=3 n=1

(8) p=2, q=1, r=2, n=1

(9) p=1, q=1, r=1, n=3

(10) p=0, q=1, r=3, n=1

(11) p=0, q=1, r=2, n=2

(12) p=1, q=1, r=2, n=2

(13) p=2, q=1, r=1, n=2

(14) p=2, q=0, r=1, n=1

(15) p=1, q=0, r=2, n=1

Preferable combinations are (1) p=3, q=0, r=0, n=1, (2) p=4, q=0, r=0, n=1, (4) p=1, q=1, r=1, n=1, (14) p=2, q=0, r=1, n=1, or (15) p=1, q=0, r=2, n=1; more preferable combinations are (1) p=3, q=0, r=0, n=1, (4) p=2, q=1, r=1, n=1, (14) p=2, q=0, r=1, n=1, or (15) p=1, q=0, r=2, n=1; still more preferable combinations are (4) p=2, q=1, r=1, n=1, (14) p=1, q=0, r=1, n=1, or (15) p=1, q=0, r=2, n=1. These combinations are preferred, because in the case of each of them, the solubility in the host liquid crystal can be high so that a reflective liquid crystal element with high display performance can be provided.

Further, -{(B¹)ₚ-(Q¹)_{q}-(B²)ᵣ}ₙ—C¹ is preferable to contain a partial structure to exhibit the liquid crystal property. Herein, the liquid crystal represents a nematic liquid crystal, a smectic liquid crystal, or a discotic liquid crystal. In particular, nematic liquid crystals are preferred, because they have a low driving voltage and a high response speed and can be driven in a wide temperature range. Examples of liquid crystal compounds include those described in Ekisho Binran Henshuu Iinkai (ed.), Ekisho Binran (Handbook of Liquid Crystals), Chapter 3, “Bunshi Kozo to Ekisho-sei (Molecular Structure and Liquid Crystallinity),” Maruzen, 2000.

Specific examples of -{(B¹)ₚ-(Q¹)_{q}-(B²)ᵣ}ₙ−C¹ are shown below, but the present invention should not be limited to them (in the following chemical Formulae, the wavy line shows the connecting position).

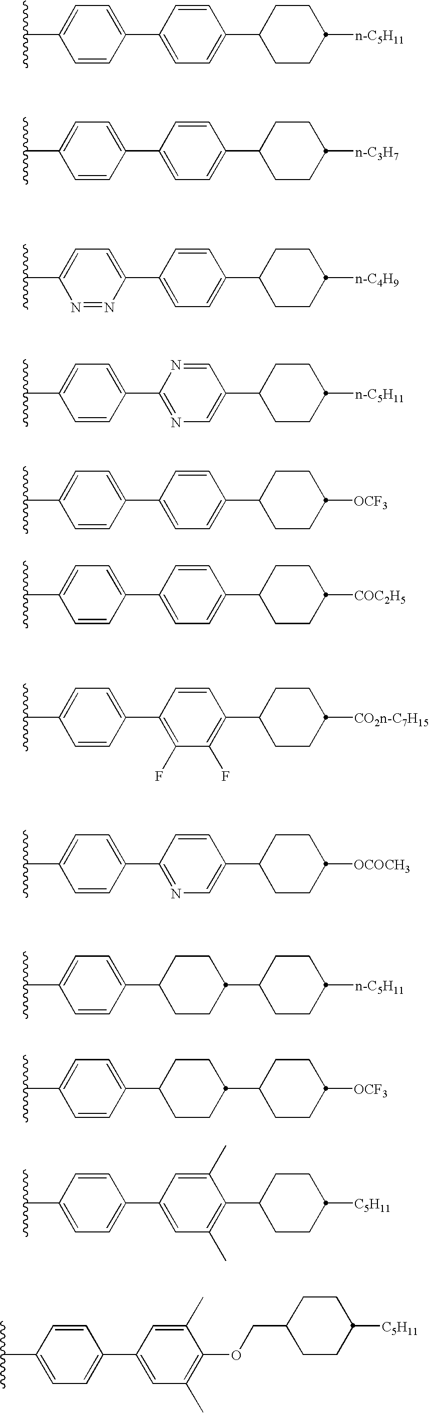

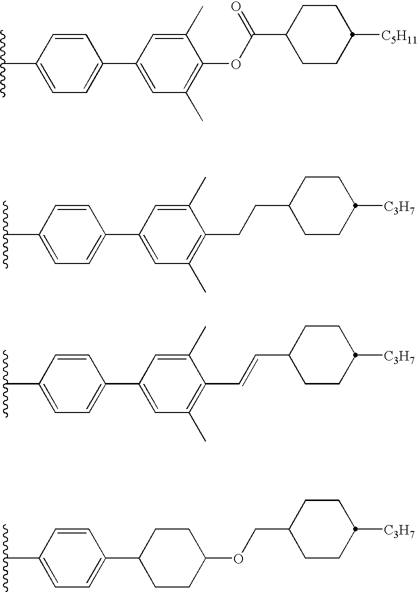

A preferred structure of the substituent represented by -{(B¹)ₚ-(Q¹)_{q}-(B²)ᵣ}ₙ—C¹ includes combinations described below.
[1] A structure in which B¹ represents an aryl group or a heteroaryl group, B² represents cyclohexane-1,4-diyl group, C¹ represents an alkyl group, p=2, q=0, r=1, and n=1.
[2] A structure in which B¹ represents an aryl group or a heteroaryl group, B² represents cyclohexane-1,4-diyl group, C¹ represents an alkyl group, p=2, q=1, r=1 and n=1.

Especially preferred structures are:
[1] A structure represented by the following Formula (a-1), in which B¹ represents a 1,4-phenylene group, B² represents a trans-cyclohexyl group, C¹ represents an alkyl group (preferably, methyl, ethyl, propyl, butyl, pentyl, or hexyl), and p=2, q=0, r=1 and n=1, and
[2] A structure represented by the following Formula (a-2), in which B′ represents a 1,4-phenylene group, B² represents trans-cylohexane-1,4-diyl, C¹ represents an alkyl group (preferably, methyl, ethyl, propyl, butyl, pentyl, or hexyl), and p=2, q=1, r=1 and n=1.

The structure represented by Formula (a-1) or (a-2) is preferred, because it has a high degree of order and high solubility in the host liquid crystal, so that it can form a reflective liquid crystal element with high display performance.

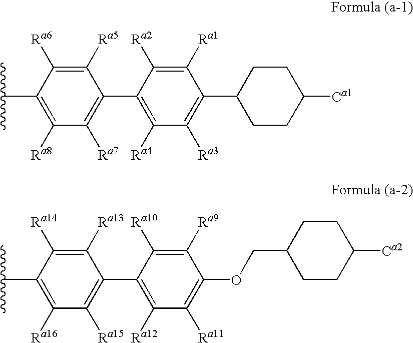

In the Formulae (a-1) and (a-2), R^{a1} to R^{a16} each independently represents a hydrogen atom or a substituent. The substituent includes, for example, a substituent selected from the substituent group V.

R^{a1} to R^{a16} each independently represents preferably hydrogen atom, a halogen atom (particularly, fluorine atom), an alkyl group, an aryl group, and an alkoxy group. Among the alkyl group, aryl group, and alkoxy group represented by R^{a1} to R^{a12}, preferred are those identical with the alkyl group, aryl group, and alkoxy group described for the substituent group V.

In Formulae (a-1) and (a-2), R^{a1}, R^{a3}, R^{a9}, and R^{a11} each preferably represent a substituent, because the solubility is improved in such a case.

The substituent represented by each of R^{a1}, R^{a3}, R^{a9}, and R^{a11} is preferably an alkyl group, an aryl group or an alkoxy group, more preferably an alkyl group having 1 to 6 carbon atoms, even more preferably a methyl group.

In the Formulae (a-1) and (a-2), C^{a1} and C^{a2} each independently represents an alkyl group, and preferably an alkyl group having 1 to 20 carbon atoms, more preferably 1 to 10 carbon atoms, and particularly preferably methyl, ethyl, propyl, butyl, pentyl, hexyl, heptyl, octyl, or nonyl.

Among the Formulae (a-1) and (a-2), particularly C^{a1} and C^{a2}, which are a straight chain alkyl group having 3 to 10 carbon atoms, is suitable for use in the reflective liquid crystal element, because the solubility in the host liquid crystal is improved and the amount of light absorbed in the colored state is increased. The reason is not clarified, but it is guessed that the reason would be in the improvement in the compatibility with the host liquid crystal.

In Formula (1), the substituent for R¹ to R⁸ which is not represented by -(Het)ₘ-{(B¹)ₚ-(Q¹)_{q}(B²)ᵣ}ₙ—C¹ is typically selected from the substituent group V, while it may be any substituent.

In Formula (1), R¹, R⁴, R⁵, and R⁸ preferably each independently represent a hydrogen atom, an alkyl group, an aryl group, an alkoxy group (including the substituent represented by -(Het)ₘ-{(B¹)ₚ-(Q¹)_{q}-(B²)ᵣ}ₙ—C¹, in which: Het represents an oxygen atom), an aryloxy group (including the substituent represented by -(Het)ₘ-{(B¹)ₚ-(Q¹)_{q}-(B²)ᵣ}ₙ—C¹, in which Het represents an oxygen atom), a halogen atom, an amino group, a substituted amino group (including the substituent represented by -(Het)ₘ-{(B¹)ₚ-(Q¹)_{q}-(B²)ᵣ}ₙ—C¹, in which Het represents NR), a hydroxy group, an alkylthio group, or an arylthio group (including the substituent represented by -(Het)ₘ-{(B¹)ₚ-(Q¹)_{q}-(B²)ᵣ}ₙ—C¹, in which Het represents a sulfur atom); more preferably a hydrogen atom, an amino group, a substituted amino group, a hydroxy group, an arylthio group, or an aryl group. At least one of R¹, R⁴, R⁵, and R⁸ more preferably represents an arylthio group or a substituted amino group.

In particular, at least R¹ preferably represents an arylthio group or a substituted amino group, and R¹ and R⁵ each preferably represent an arylthio group or a substituted amino group, because the maximum absorption wavelength falls within in the visible light range in such a case.

Specific examples of the dichroic dyes which can be used in the present invention will be shown below, but the present invention should not be limited at all by the following specific examples.

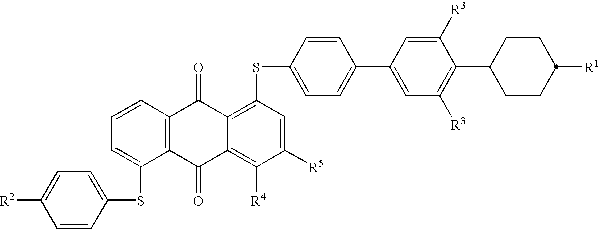

| No. | R¹ | R² | R³ | R⁴ | R⁵ |
|---|---|---|---|---|---|
| A-1 | C₅H₁₁ | t-Bu | H | H | H |
| A-2 | C₅H₁₁ | Iso-Bu | H | H | H |
| A-3 | C₃H₇ | n-C₆H₁₃ | CH₃ | H | H |
| A-4 | C₄H₉ | n-Bu | F | H | H |
| A-5 | OC₄H₉ | OCH₃ | H | H | H |
| A-6 | C₅H₁₁ | t-Bu | H | OH | H |
| A-7 | C₅H₁₁ | t-Bu | H | H | CH₃ |

Bu represents butyl.

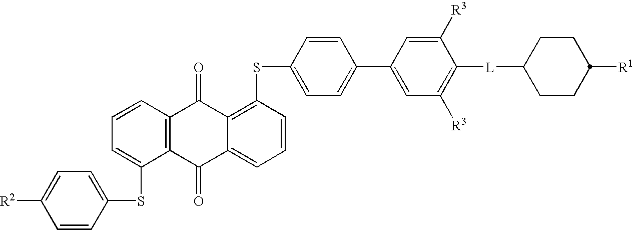

| No. | R¹ | R² | R³ | L |
|---|---|---|---|---|
| A-8 | C₅H₁₁ | t-Bu | H | *—OCH₂— |
| A-9 | C₅H₁₁ | t-Bu | CH₃ | *—OCH₂— |
| A-10 | C₃H₇ | n-C₆H₁₃ | CH₃ | *—OCH₂— |
| A-11 | C₄H₉ | n-Bu | F | *—(C═O)CH₂— |
| A-12 | O(C═O)C₄H₉ | OCH₃ | H | *—O(C═O)— |
| A-13 | (C═O)OC₅H₁₁ | t-Bu | CH₃ | *—(C═O)O— |

For L, *represents the bonding position to the benzene ring, and — represents a bond.

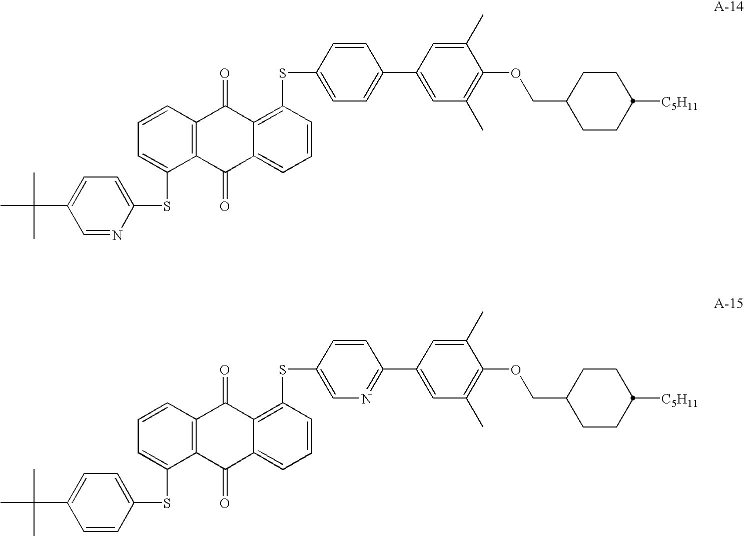

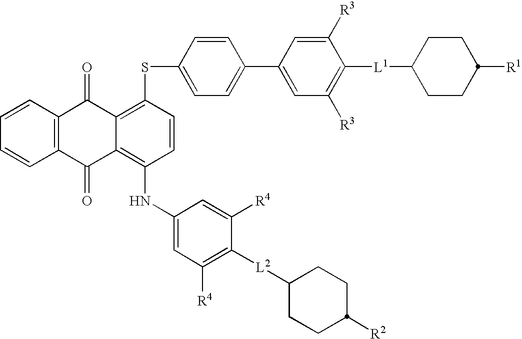

| No. | R¹ | R² | R³ | R⁴ | L¹ | L² |
|---|---|---|---|---|---|---|
| B-1 | n-C₅H₁₁ | n-C₅H₁₁ | H | H | *—OCH₂— | *—OCH₂— |
| B-2 | n-C₅H₁₁ | n-C₃H₇ | H | H | *—OCH₂— | *—OCH₂— |
| B-3 | n-C₃H₇ | n-C₆H₁₃ | CH₃ | H | *—OCH₂— | *—OCH₂— |
| B-4 | n-C₄H₉ | n-C₄H₉ | F | H | *—(C═O)CH₂— | *—(C═O)CH₂— |
| B-5 | OC₄H₉ | (C═O)C₄H₉ | H | Cl | *—OCH₂— | *—O(C═O)— |
| B-6 | (C═O)OC₄H₉ | n-C₃H₇ | H | CH₃ | *—CH₂O— | *—(C═O)O— |
| B-7 | n-C₅H₁₁ | n-C₅H₁₁ | CH₃ | CH₃ | *—OCH₂— | *—OCH₂— |
| B-8 | n-C₃H₇ | n-C₃H₇ | CH₃ | CH₃ | *—OCH₂— | *—OCH₂— |

For L¹ and L², *represents the bonding position to the benzene ring, and — represents a bond. The same applies to the examples of the dichroic dye shown below.

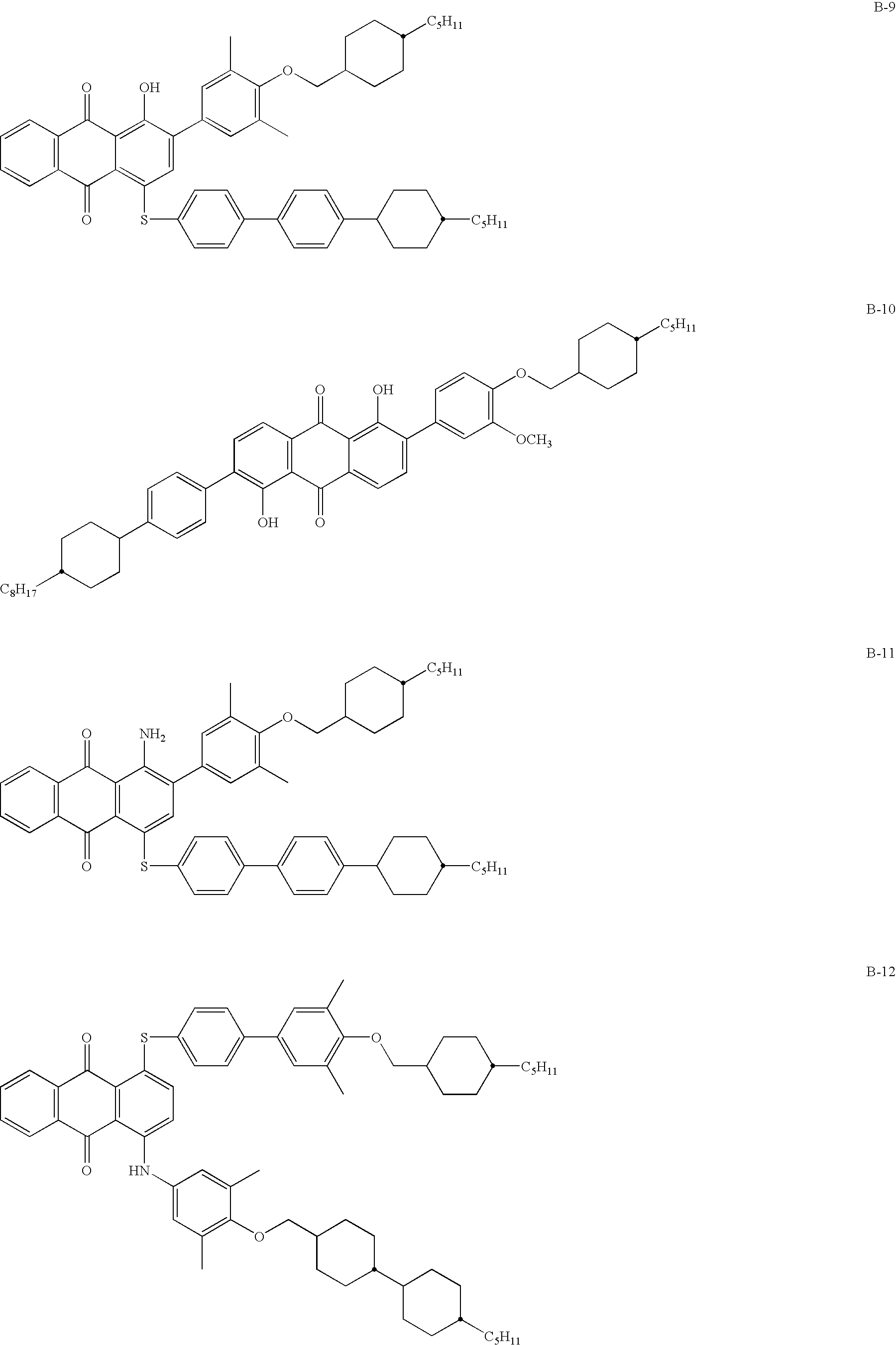

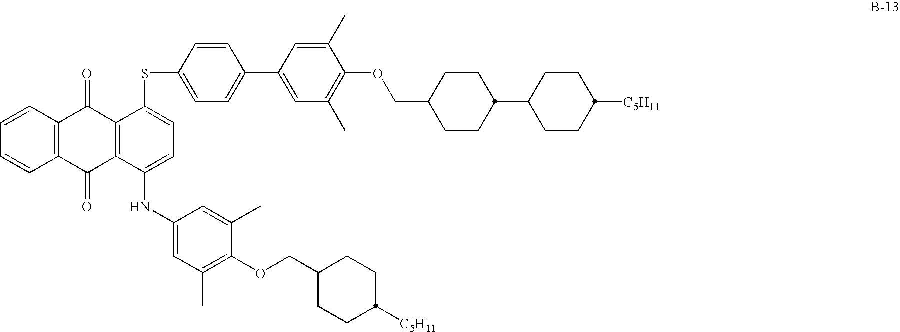

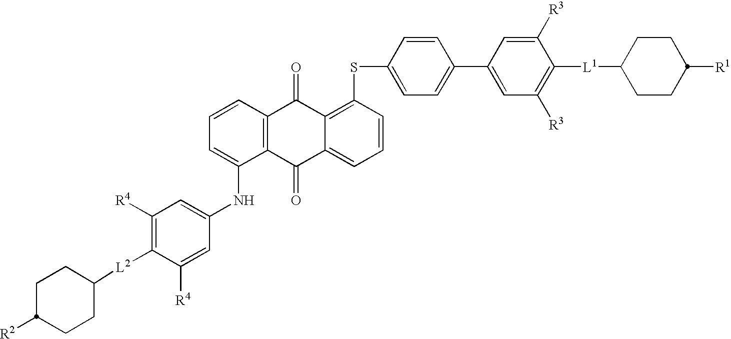

| No. | R¹ | R² | R³ | R⁴ | L¹ | L² |
|---|---|---|---|---|---|---|
| C-1 | n-C₅H₁₁ | n-C₅H₁₁ | H | H | *—OCH₂— | *—OCH₂— |
| C-2 | n-C₅H₁₁ | n-C₃H₇ | H | H | *—OCH₂— | *—OCH₂— |
| C-3 | n-C₃H₇ | n-C₆H₁₃ | CH₃ | H | *—OCH₂— | *—OCH₂— |
| C-4 | n-C₄H₉ | n-C₄H₉ | F | H | *—(C═O)CH₂— | *—(C═O)CH₂— |
| C-5 | OC₄H₉ | (C═O)C₄H₉ | H | Cl | *—OCH₂— | *—O(C═O)— |
| C-6 | (C═O)OC₄H₉ | n-C₃H₇ | H | CH₃ | *—CH₂O— | *—(C═O)O— |
| C-7 | n-C₅H₁₁ | n-C₅H₁₁ | CH₃ | CH₃ | *—OCH₂— | *—OCH₂— |
| C-8 | n-C₃H₇ | n-C₃H₇ | CH₃ | CH₃ | *—OCH₂— | *—OCH₂— |

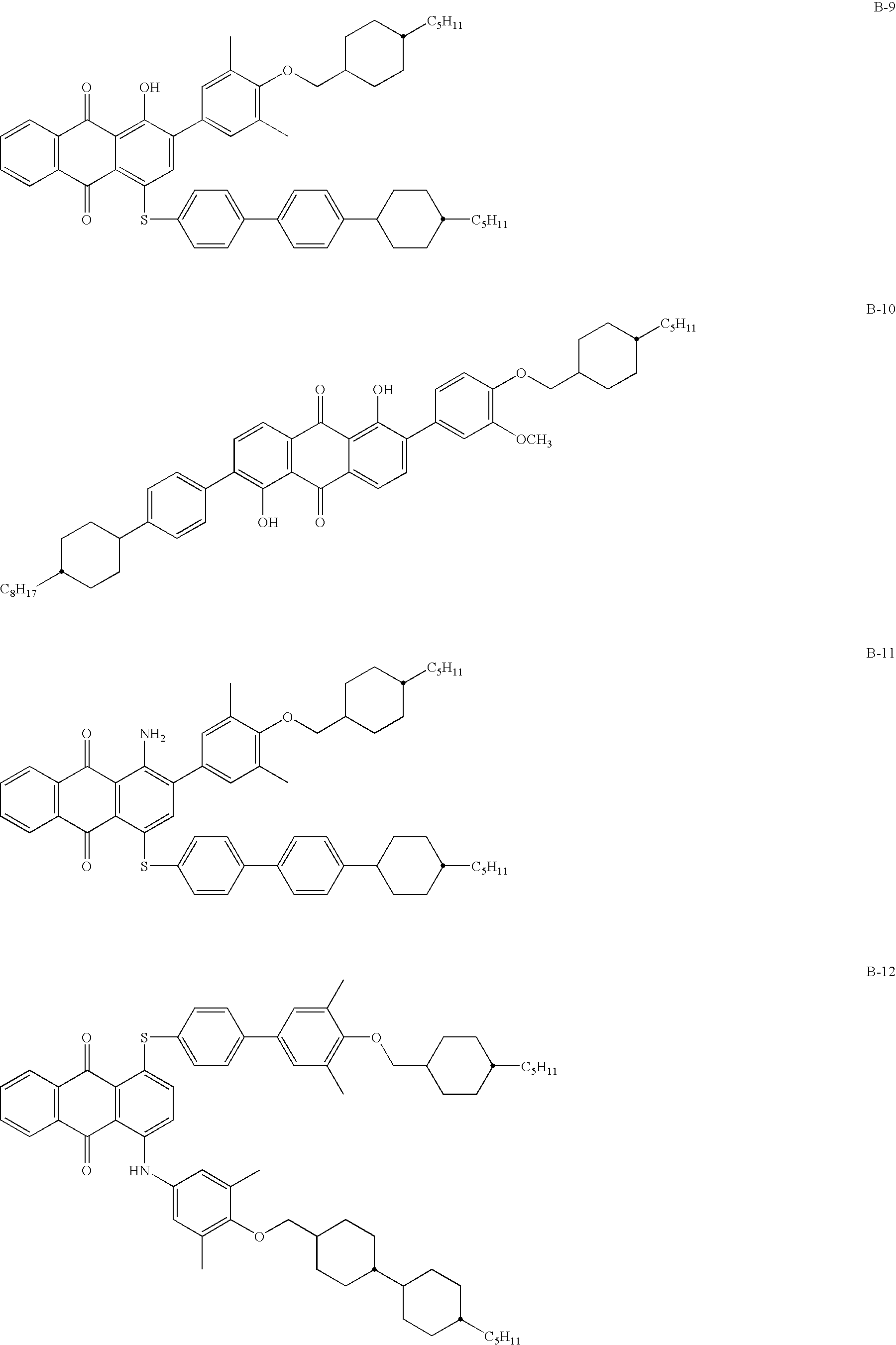

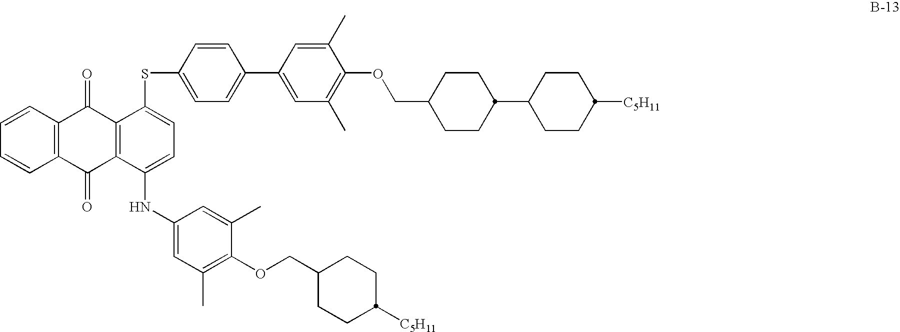

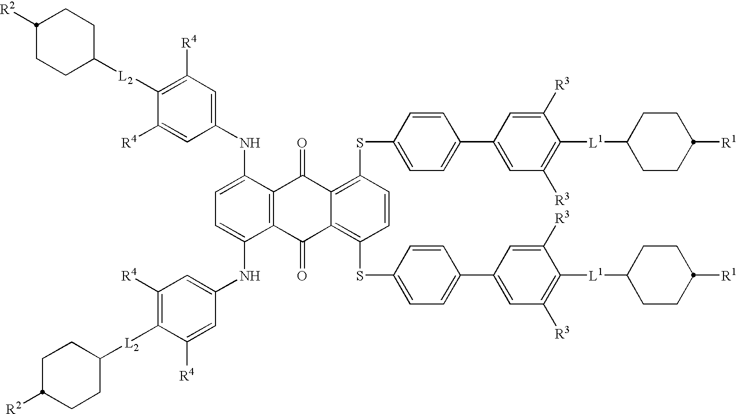

| No. | R¹ | R² | R³ | R⁴ | L¹ | L² |
|---|---|---|---|---|---|---|
| D-1 | n-C₅H₁₁ | n-C₅H₁₁ | H | H | *—OCH₂— | *—OCH₂— |
| D-2 | n-C₅H₁₁ | n-C₃H₇ | H | H | *—OCH₂— | *—OCH₂— |
| D-3 | n-C₃H₇ | n-C₆H₁₃ | CH₃ | H | *—OCH₂— | *—OCH₂— |
| D-4 | n-C₄H₉ | n-C₄H₉ | F | H | *—(C═O)CH₂— | *—(C═O)CH₂— |
| D-5 | OC₄H₉ | (C═O)C₄H₉ | H | Cl | *—OCH₂— | *—O(C═O)— |
| D-6 | (C═O)OC₄H₉ | n-C₃H₇ | H | CH₃ | *—CH₂O— | *—(C═O)O— |
| D-7 | n-C₅H₁₁ | n-C₅H₁₁ | CH₃ | CH₃ | *—OCH₂— | *—OCH₂— |
| D-8 | n-C₃H₇ | n-C₃H₇ | CH₃ | CH₃ | *—OCH₂— | *—OCH₂— |
| D-9 | n-C₅H₁₁ | n-C₅H₁₁ | CH₃ | CH₃ | *—O(C═O)— | *—CH₂CH₂— |
| D-10 | n-C₃H₇ | n-C₃H₇ | CH₃ | CH₃ | *—(C═O)O— | *—CF₂O— |

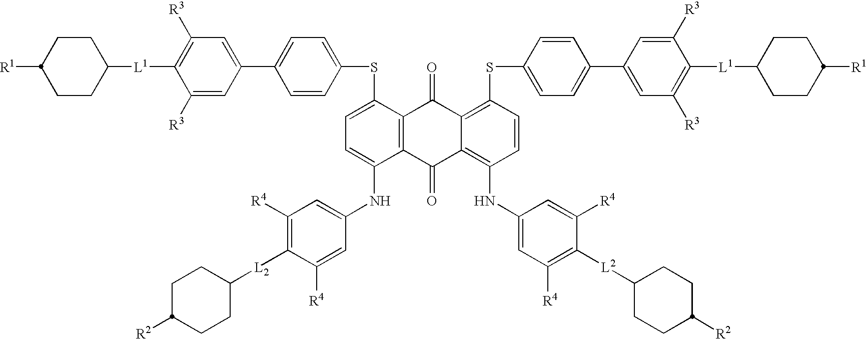

| No. | R¹ | R² | R³ | R⁴ | L¹ | L² |
|---|---|---|---|---|---|---|
| D-11 | n-C₅H₁₁ | n-C₅H₁₁ | H | H | *—OCH₂— | *—OCH₂— |
| D-12 | n-C₅H₁₁ | n-C₃H₇ | H | H | *—OCH₂— | *—OCH₂— |
| D-13 | n-C₃H₇ | n-C₆H₁₃ | CH₃ | H | *—OCH₂— | *—OCH₂— |
| D-14 | n-C₄H₉ | n-C₄H₉ | F | H | *—(C═O)CH₂— | *—(C═O)CH₂— |
| D-15 | OC₄H₉ | (C═O)C₄H₉ | H | Cl | *—OCH₂— | *—O(C═O)— |
| D-16 | (C═O)OC₄H₉ | n-C₃H₇ | H | CH₃ | *—CH₂O— | *—(C═O)O— |
| D-17 | n-C₅H₁₁ | n-C₅H₁₁ | CH₃ | CH₃ | *—OCH₂— | *—OCH₂— |
| D-18 | n-C₃H₇ | n-C₃H₇ | CH₃ | CH₃ | *—OCH₂— | *—OCH₂— |
| D-19 | n-C₅H₁₁ | n-C₅H₁₁ | CH₃ | CH₃ | *—O(C═O)— | *—CH₂CH₂— |
| D-20 | n-C₃H₇ | n-C₃H₇ | CF₃ | CF₃ | *—CH═CH— | Single |
| | | | | | | bond |

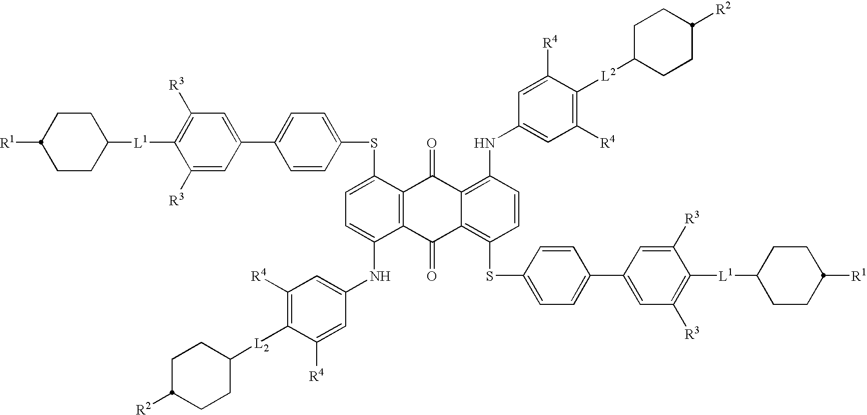

| No. | R¹ | R² | R³ | R⁴ | L¹ | L² |
|---|---|---|---|---|---|---|
| D-21 | n-C₅H₁₁ | n-C₅H₁₁ | H | H | *—OCH₂— | *—OCH₂— |
| D-22 | n-C₅H₁₁ | n-C₃H₇ | H | H | *—OCH₂— | *—OCH₂— |
| D-23 | n-C₃H₇ | n-C₆H₁₃ | CH₃ | H | *—OCH₂— | *—OCH₂— |
| D-24 | n-C₄H₉ | n-C₄H₉ | F | H | *—(C═O)CH₂— | *—(C═O)CH₂— |
| D-25 | OC₄H₉ | (C═O)C₄H₉ | H | Cl | *—OCH₂— | *—O(C═O)— |
| D-26 | (C═O)OC₄H₉ | n-C₃H₇ | H | CH₃ | *—CH₂O— | *—(C═O)O— |
| D-27 | n-C₅H₁₁ | n-C₅H₁₁ | CH₃ | CH₃ | *—OCH₂— | *—OCH₂— |
| D-28 | n-C₃H₇ | n-C₃H₇ | CH₃ | CH₃ | *—OCH₂— | *—OCH₂— |
| D-29 | n-C₅H₁₁ | n-C₅H₁₁ | CH₃ | CH₃ | *—O(C═O)— | *—CH₂CH₂— |
| D-30 | n-C₃H₇ | n-C₃H₇ | CH₃ | CH₃ | Single | *—CF₂O— |
| | | | | | bond | |

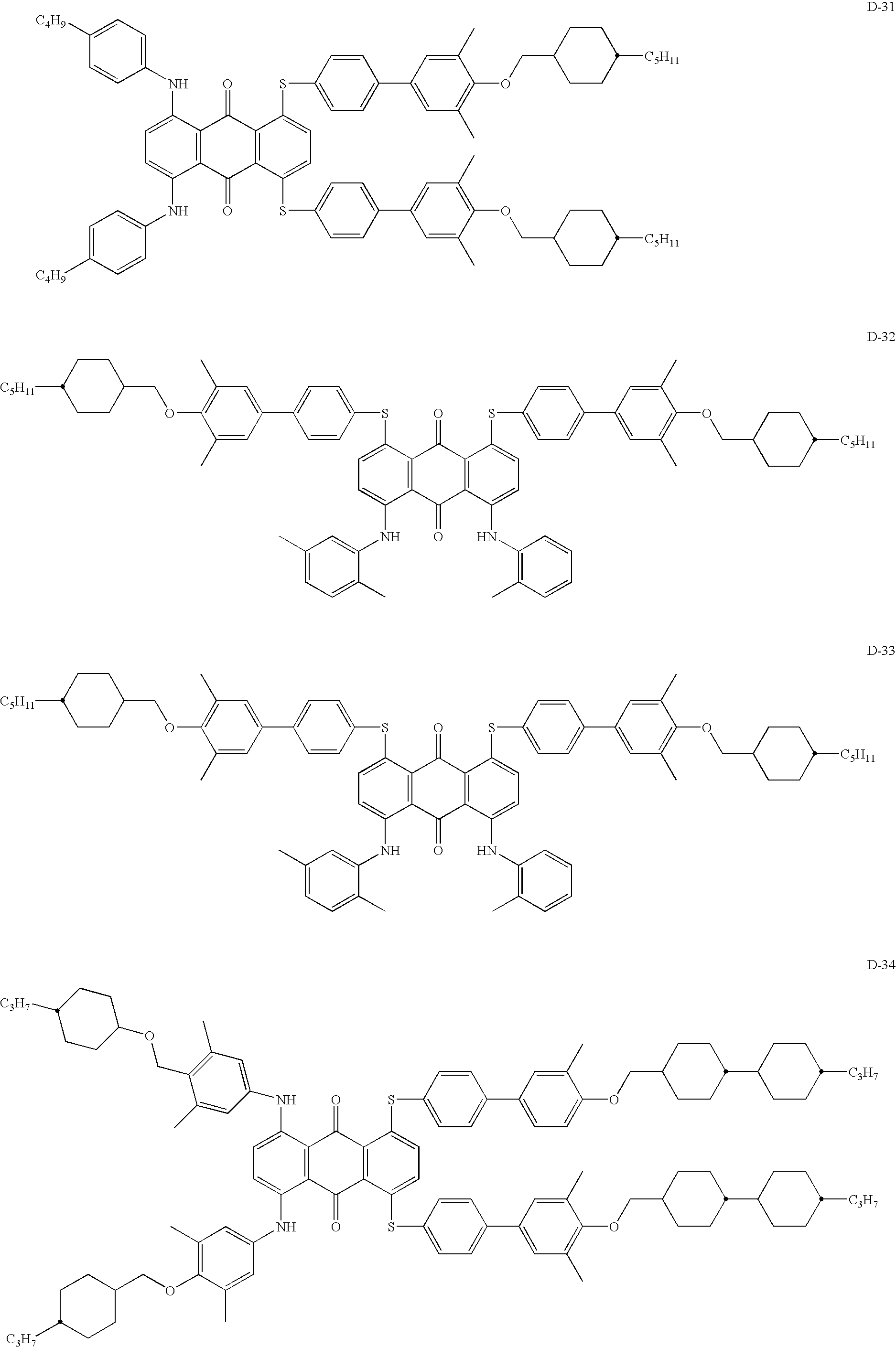

The dichroic dyes represented by the Formula (1), can be synthesized by combining the known methods. For example, they can be synthesized according to the methods described in Alexander V. Ivashchenko, DICHROIC DYES for LIQUID CRYSTAL DISPLAYS (CRC Press), JP-A No. 2003-192664 and the like.

(The Host Liquid Crystal)

The host liquid crystal which can be used in the light modulating material of the present invention is defined as a compound having such a function that changes its aligned state by the action of the electric field to control the aligned state of the dichroic dye, which has been dissolved as a guest, represented by the Formula (1).

In the present invention, as a host liquid crystal, a liquid crystal compounds which exhibit the nematic phase may be used.

Specific examples of nematic liquid crystal compounds include azomethine compounds, cyanobiphenyl compounds, cyanophenyl esters, fluorine substituted phenyl ester, phenyl cyclohexanecarboxylate ester, fluorine substituted phenyl cyclohexanecarboxylate ester, cyanophenylcyclohexane, fluorine substituted phenylcyclohexane, cyano substituted phenylpyrimidine, fluorine substituted phenylpyrimidine, alkoxy substituted phenylpyrimidine, fluorine and alkoxy substituted phenylpyrimidine, phenyldioxane, tolan-based compounds, fluorine substituted tolan-based compounds, and alkenylcyclohexyl benzonitrile. Liquid crystal compounds described in the pages of 154 to 192 and 715 to 722 of “Liquid crystal device handbook” (edited by the 142nd Committee in Japan Society for the Promotion of Science, Nikkan Kogyo Shimbun, Ltd., 1989) may be used as reference.

Examples of a commercially products of the host liquid crystal include liquid crystals manufactured by Merck & Co., Inc. (ZLI-4692, MLC-6267, 6284, 6287, 6288, 6406, 6422, 6423, 6425, 6435, 6437, 7700, 7800, 9000, 9100, 9200, 9300, 10000, and the like); liquid crystals manufactured by Chisso Co., ltd. (LIXON5036xx, 5037xx, 5039xx, 5040xx, 5041xx, and the like); and the liquid crystal of Asahi Denka Kogyo K.K. (HA-11757).

The dielectric constant anisotropy of a host liquid crystal used in the present invention may be positive or negative.

In a case where a host liquid crystal with positive dielectric constant anisotropy is horizontally aligned, the liquid crystal is horizontally aligned when no voltage is applied, so that the dichroic dye is also horizontally aligned to absorb light, when no voltage is applied. When a certain voltage is applied, the liquid crystal molecules are vertically aligned, and therefore, the dichroic dye is also vertically aligned, so that light is transmitted. Thus, a colourless state is achieved when a certain voltage is applied, and a colored state is achieved when no voltage is applied.

In a case where a host liquid crystal with negative dielectric constant anisotropy is vertically aligned, the liquid crystal is vertically aligned when no voltage is applied, so that the dichroic dye is also vertically aligned to transmit light without absorbing it, when no voltage is applied. When a certain voltage is applied, the liquid crystal molecules are horizontally aligned, and therefore, the dichroic dye is also horizontally aligned, so that light is absorbed. Thus, a colourless state is achieved when no voltage is applied, and a colored state is achieved when a certain voltage is applied.

To make a liquid crystal with negative permittivity anisotropy, it is necessary to make a structure so that the minor axis of the liquid crystal molecule has a substituent which has large permittivity anisotropy. For example, those described in the pages 4 to 9 of “Monthly Display” (the April number, 2000) and in the pages 389 to 396 of Syn Lett., vol. 4, 1999 are enumerated. Examples of a commercially products include liquid crystals (ZLI-2806 and the like) manufactured by Merck & Co., Inc.

Among these host liquid crystals, a liquid crystal which has a fluorine substituent and has a negative of permittivity anisotropy is preferable, from the viewpoint of the voltage retention. These examples include MLC-6608, 6609, 6610 and the like, which are liquid crystals manufactured by Merck & Co., Inc.

When the dichroic dye represented by Formula (1) is used in combination with plural chiral reagents according to the present invention, display with sufficiently high optical density can be achieved even in a case where a host liquid crystal having a fluorine-containing substituent is used in combination with them.

In addition, the liquid crystal composition and the reflective display element of the present invention can also use a liquid crystal exhibiting a dual wavelength addressing property. A dual frequency addressable liquid crystal is a liquid crystal, which exhibits positive permittivity anisotropy when the frequency of the electric field applied to the liquid crystal is a low frequency area, and the permittivity anisotropy reverses negative when the frequency of the electric field applied to the liquid crystal is a high frequency area. It is detailed in the pages of 189 to 192 in Liquid crystal device handbook, edited by the 142nd committee in Japan Sciety for the Promotion of Science, the Nikkan Kogyo Shimbun Ltd., 1989.

Further, in case of switching a transparent colored state and a transparent colorless state, the host liquid crystal used in the present invention has preferably small absolute value of a refractive index anisotropy (Δn), and in case of switching a scattered colored state and a transparent colorless state, the host liquid crystal has preferably large absolute value of a refractive index anisotropy (Δn). Refractive index anisotropy (Δn) herein is defined as the difference between the refractive index (n∥) in the major axis direction of the liquid crystal molecule and the refractive index (n⊥) in the minor axis direction of the liquid crystal molecule.

Δn=n∥−n⊥

When the phase transition method is used as a method to switch a transparent colored state and a transparent colorless state, a liquid crystal has the small absolute value of Δn, and preferably less than Δn=0.1. It is because the waving guide in the helical structure is controlled to decrease optical leakage when Δn is small, resulting in the improvement in the reflective display performance.

On the other hand, when the phase transition method is used as a method to switch a scattered colored state and a transparent colorless state, a liquid crystal has the large absolute value of An, and preferably Δn=0.1 or more, and more preferably Δn=0.12 or more. It is because that in the scattered state based on the random focal conic state, the larger the Δn of the host liquid crystal, the higher the scattered strength, resulting in the improvement in the reflective display performance.

While the content of a host liquid crystal and a dichroic dye are not particularly restricted in the reflective display material of the present invention, the content of the dichroic dye is preferably from 0.1 to 15% by mass based on the content of the host liquid crystal, more preferably from 0.5 to 10% by mass, and further preferably from 1 to 8% by mass. Moreover, as for the content of the host liquid crystal and the dichroic dye, it is desirable that the liquid crystal composition including both materials is formed, and the absorption spectrums of the liquid crystal cell which encloses the liquid crystal composition are measured respectively, and the dye density is decided which is necessary to provide the desired optical density as a liquid crystal cell.

The dichroic dye (including the anthraquinone dye according to the present invention) may be dissolved in the host liquid crystal using mechanical stirring, heating, ultrasonic wave, or any combination thereof. In addition, known methods may be used for preparing the liquid crystal composition of the present invention.

In order to control the hue, an additional dichroic dye other than the anthraquinone dye according to the present invention may be further added. The content of the anthraquinone dye according to the present invention with regard to all the dichroic dyes in the liquid crystal composition is preferably from 50 to 100% by mass, and more preferably from 65 to 100% by mass.

(Chiral Reagent)

A chiral reagent which may be use in the present invention include chiral reagents for TN and STN, which are described in the pages of 199 to 202 of “Liquid crystal device handbook” (edited by the 142nd Committee in Japan Society for the Promotion of Science, Nikkan Kogyo Shimbun, Ltd., 1989).

When a chiral reagent is added, the cholesteric liquid crystal phase is formed, and the dichroic dye, which is dissolved in the nematic liquid crystal, will be spirally arranged. Therefore, it is suitable because both polarized lights can be absorbed for linear polarized lights being orthogonal to each other, and the absorbed amount of light in the colored state is increased. On the other hand, when the nematic liquid crystal layer which has been made in uniaxial alignment is used, as for light, only half theoretical will be absorbed.

The amount of the chiral reagent added is preferably from 0.1 to 30% by mass in the liquid crystal composition, more preferably from 0.5 to 20% by mass, and further preferably from 1 to 10% by mass. When the chiral reagent is more than 30% by mass, the selective reflection might be shown in the visible range to decrease the reflective display performance, or it might be easy for the chiral reagent to separate out from the host liquid crystal.

In an embodiment of the present invention, two or more chiral reagents are used in combination.

It is thought that when a combination of different plural types of chiral reagents is used, the interaction between the dichroic dye represented by Formula (1) and the respective chiral reagents can be made weaker than that between the dichroic dye represented by Formula (1) and the host liquid crystal and, therefore, the interaction between the dichroic dye and the host liquid crystal can be maintained so that the dichroic dye can be present close to the host liquid crystal thereby showing a high order parameter and exhibiting high color development in a horizontal alignment state.

It is also thought that when a combination of different plural types of chiral reagents is used, the dichroic dye represented by Formula (1) can also show a high order parameter in a vertical state for the same reason, so that high light transmittance can be provided in the vertical alignment state.

In addition, the response speed can be increased using the dichroic dye represented by Formula (1) in combination with different plural types of chiral reagents. It is thought that this is because when different plural types of chiral reagents are used, the interaction between the dichroic dye and the host liquid crystal can be maintained and, therefore, the dichroic dye can be present close to the host liquid crystal, so that not only the dielectric constant of the host liquid crystal but also the dielectric constant of the dichroic dye itself can contribute to the response. Based on a molecular orbital calculation, the dielectric constant of the dichroic dye represented by Formula (1) is thought to be equal to or higher than that of the host liquid crystal, although precise data are not available.

In particular, two or more chiral reagents having different main structures are preferably used in combination. As used herein, the main structure of the chiral reagent generally refers to a portion of the chiral reagent structure other than the liquid crystalline portion and the linking portion to the liquid crystalline portion. Such a portion may be identified by the portion bonded to the asymmetric carbon atom of the chiral reagent.

Examples of the main structure of the chiral reagent include aromatic ester derivatives, aromatic ether derivatives, aliphatic ester derivatives, aliphatic ether derivatives, cyclic aliphatic derivatives, and cholesterol derivatives. Preferred are aromatic ester derivatives, aromatic ether derivatives, cyclic aliphatic derivatives, and cholesterol derivatives.

As used herein, the term “aromatic ester derivatives chiral reagent” refers to an aromatic group-containing chiral reagent having an ester group in a moiety bonded to the asymmetric carton atom.

The term “aromatic ether derivatives chiral reagent” refers to an aromatic group-containing chiral reagent having an ether group in a moiety bonded to the asymmetric carbon atom.

The term “aliphatic ester derivatives chiral reagent” refers to a chiral reagent having an ester group in a moiety bonded to the asymmetric carbon atom and composed by only aliphatic group except the ester group, or a chiral reagent in which the asymmetric carbon atom forms a cyclic aliphatic ester group.

The term “aliphatic ether derivatives chiral reagent” refers to a chiral reagent having an ether group in a moiety bonded to the asymmetric carbon atom and composed by only aliphatic group except the ether group, or a chiral reagent in which the asymmetric carbon atom forms a cyclic aliphatic ether group.

The term “cyclic aliphatic derivatives chiral reagent” refers to a chiral reagent having a structure in which the asymmetric carbon atom forms a cyclic aliphatic group.

The term “cholesterol derivatives chiral reagent” refers to a chiral reagent having a cholesterol structure.

In particular, at least one of the different plural types of chiral reagents used in combination preferably includes a cholesterol derivatives chiral reagent, so that both high display performance and high response speed can be achieved.

The cholesterol derivatives chiral reagent is more preferably a chiral reagent represented by Formula (2) shown below.

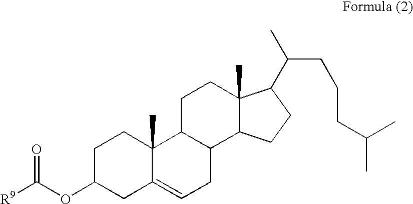

In Formula (2), R⁹ represents an alkyl group.

The alkyl group represented by R⁹ may be any of a straight chain alkyl group, a branched chain alkyl group and a cyclic alkyl group. It is preferably a straight chain alkyl group, because the mixture of the chiral reagent and the host liquid crystal can provide a high order parameter in such a case.

The alkyl group represented by R⁹ preferably has 1 to 20 carbon atoms, more preferably 1 to 16 carbon atoms, and even more preferably 1 to 15 carbon atoms.

The alkyl group represented by R⁹ may further have a substituent, which may be any of the substituents in the substituent group V. In particular, the substituent for the alkyl group represented by R⁹ is preferably a liquid crystalline group linked through an ester bond.

In an embodiment of the present invention, the chiral reagent is preferably such that the addition of it to the host liquid crystal raises the transition temperature (Tᵢₛₒ) at which the host liquid crystal changes from a liquid crystal state to an isotropic state. The transition temperature (Tᵢₛₒ) is preferably raised by from 0.1 to 50° C., more preferably from 0.1 to 20° C., and even more preferably from 0.1 to 15° C. due to an addition of the chiral reagent. A rigid chiral reagent can significantly raise the transition temperature (Tᵢₛₒ), and in particular, a cholesterol derivatives chiral reagent is preferably used.

When the transition temperature (Tᵢₛₒ) is raised, the degree of order of the host liquid crystal is also raised, so that the display contrast of the guest-host liquid crystal element containing the dichroic dye is advantageously enhanced.

The nematic liquid crystal material containing the chiral reagents according to the present invention preferably has a chiral pitch of from 1.0 μm to 100 μm, more preferably from 1.0 to 10 μm, and even more preferably from 3.0 to 15 μm.

When the chiral pitch is in the above range, a reduction in reflection and absorption of light in the visible range can be suppressed so that the degradation of the display performance can be prevented, and the precipitation of the chiral reagent from the host liquid crystal can be suppressed.

The ratio (P/G) of the chiral pitch (P) to the thickness (G) of the liquid crystal layer (the gap between the electrodes) is preferably with in the rang of from 10% to 1,000%, more preferably from 15% to 500%, and even more preferably from 20% to 200%. When the P/G value is in the above range, a reduction in reflection and absorption of light in the visible range can be suppressed so that the degradation of the display performance can be prevented, and the viscosity of the host liquid crystal composition can be kept within an appropriate range, which is also preferred in terms of response speed.

The chiral pitch may be positively or negatively dependent on temperature. In a preferred mode, a material whose chiral pitch is positively dependent on temperature is used in combination with another material whose chiral pitch is negatively dependent on temperature, so that the temperature dependence of the chiral pitch is reduced.

Some examples of the chiral reagent for use in the present invention are shown below, in which * represents an optically-active portion.

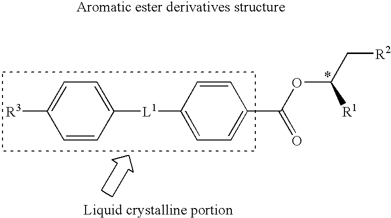

| No. | R¹ | R² | R³ | L¹ |
|---|---|---|---|---|
| CA-1 | CH₃ | n-C₄H₉ | OC₆H₁₃ | *—(C═O)O— |
| CA-2 | CH₃ | n-C₄H₉ | C₆H₁₃ | *—(C═O)O— |
| CA-3 | CH₃ | n-C₄H₉ | —O(C═O)C₄H₉ | *—CH₂O— |
| CA-4 | CH₃ | OC₄H₉ | OC₆H₁₃ | Single |
| | | | | bond |
| CA-5 | C₂H₅ | O(C═O)C₄H₉ | OC₆H₁₃ | *—(C═O)O— |
| CA-6 | Ph | n-C₄H₉ | CN | *—(C═O)O— |
| CA-7 | Ph | OPh | OC₆H₁₃ | *—(C═O)O— |

For L¹, * represents the bonding position to the benzene ring provided on the right side of the above chemical formula, and — represents a bond. Ph represents phenyl.

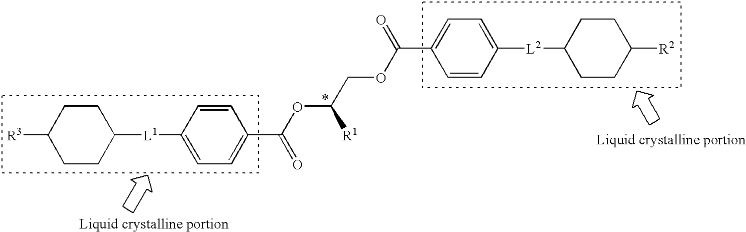

| No. | R¹ | R² | R³ | L¹ | L² |
|---|---|---|---|---|---|
| CA-8 | Ph | n-C₅H₁₁ | n-C₅H₁₁ | Single | Single |
| | | | | bond | bond |
| CA-9 | Ph | n-C₄H₉ | n-C₄H₉ | *—(C═O)O— | *—(C═O)O— |
| CA-10 | Ph | n-C₃H₇ | n-C₃H₇ | *—CH₂O— | *—CH₂O— |
| CA-11 | CH₃ | OC₄H₉ | OC₄H₉ | Single | Single |
| | | | | bond | bond |
| CA-12 | -Ph-4-CH₃ | OC₄H₉ | OC₄H₉ | *—(C═O)O— | *—(C═O)O— |
| CA-13 | Ph | n-C₄H₉ | n-C₅H₁₁ | *—(C═O)O— | Single |
| | | | | | bond |
| CA-14 | Ph | OPh | n-C₅H₁₁ | Single | Single |
| | | | | bond | bond |

For L¹ and L², * represents the bonding position to the benzene ring, and — represents a bond. Ph represents phenyl and Ph-4-CH₃ represents position 4 of phenyl is substituted by methyl.

Aromatic ether derivatives structure

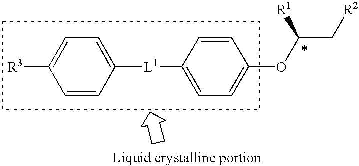

| No. | R¹ | R² | R³ | L¹ |
|---|---|---|---|---|
| CB-1 | CH₃ | n-C₄H₉ | OC₆H₁₃ | *—(C═O)O— |
| CB-2 | CH₃ | n-C₄H₉ | C₆H₁₃ | *—(C═O)O— |
| CB-3 | CH₃ | n-C₄H₉ | —O(C═O)C₄H₉ | *—CH₂O— |
| CB-4 | CH₃ | OC₄H₉ | CN | Single |
| | | | | bond |
| CB-5 | C₂H₅ | O(C═O)C₄H₉ | OC₆H₁₃ | *—(C═O)O— |
| CB-6 | Ph | n-C₄H₉ | OC₆H₁₃ | *—(C═O)O— |
| CB-7 | Ph | OPh | OC₆H₁₃ | *—(C═O)O— |

For L¹, * represents the bonding position to the benzene ring provided on the right side of the above chemical formula, and — represents a bond.

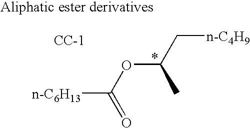

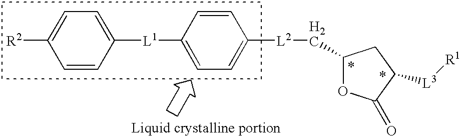

| No. | R¹ | R² | L¹ | L² | L³ |
|---|---|---|---|---|---|
| CC-2 | Ph | n-C₄H₉ | *—(C═O)O— | —O— | —O— |
| CC-3 | Ph | n-C₄H₉ | *—(C═O)O— | —(C═O)— | —O— |
| CC-4 | -Ph-Ph-4-C₅H₁₁ | n-C₄H₉ | Single | —CH₂— | *—O(C═O)— |
| | | | bond | | |
| CC-5 | CH₃ | OC₄H₉ | Single | Single | Single |
| | | | bond | bond | bond |

For L¹, * represents the bonding position to the benzene ring provided on the right side of the above chemical formula. For L³, * represents the bonding position to the γ-butyllactone ring, and — represents a bond.

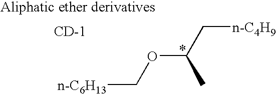

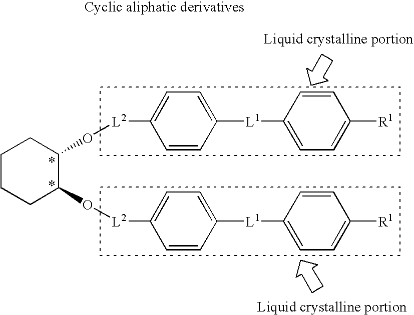

| No. | R¹ | L¹ | R² |
|---|---|---|---|
| CE-1 | n-C₄H₉ | *—(C═O)O— | —CH₂— |
| CE-2 | n-C₄H₉ | *—(C═O)O— | —(C═O)— |
| CE-3 | CN | Single bond | —CH₂— |
| CE-4 | OC₄H₉ | Single bond | Single bond |

For L¹, * represents the bonding position to the benzene ring provided on the left side of the above chemical formula, and — represents a bond.

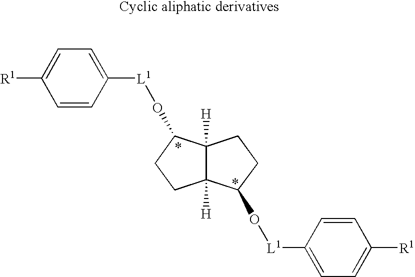

| No. | R¹ | L¹ |
|---|---|---|
| CF-1 | H | —(C═O)— |
| CF-2 | n-C₄H₉ | —CH₂— |
| CF-3 | CN | Single bond |
| CF-4 | OC₄H₉ | Single bond |
| CF-5 | OC₄H₉ | —(C═O)— |

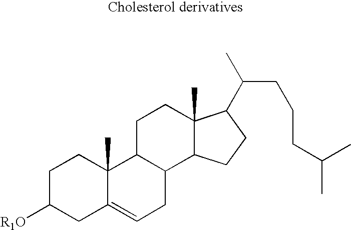

| No. | R¹ |
|---|---|
| CG-1 | CH₃ |
| CG-2 | n-C₄H₉ |
| CG-3 | n-C₅H₁₁ |
| CG-4 | —(C═O)C₄H₉ |
| CG-5 | —(C═O)NHC₄H₉ |
| CG-6 | —(C═O)-n-C₈H₁₇ |
| CG-7 | —(C═O)-n-C₉H₁₉ |
| CG-8 | Ph |
| CG-9 | —(C═O)Ph |

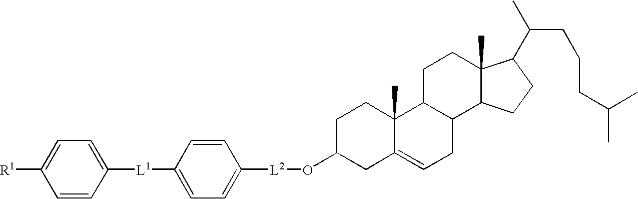

| No. | R¹ | L¹ | L² |
|---|---|---|---|
| CG-10 | n-C₄H₉ | *—(C═O)O— | —CH₂— |
| CG-11 | n-C₄H₉ | *—(C═O)O— | —(C═O)— |
| CG-12 | CN | Single bond | —CH₂— |
| CG-13 | OC₄H₉ | Single bond | Single bond |

For L¹, * represents the bonding position to the benzene ring provided on the left side of the above chemical formula, and — represents a bond.

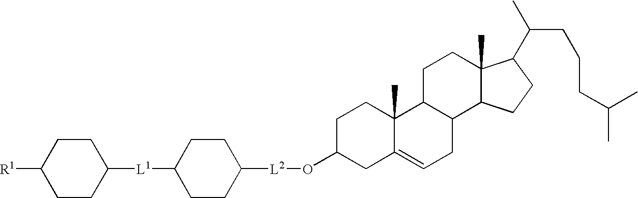

| No. | R¹ | L¹ | L² |
|---|---|---|---|
| CG-14 | n-C₄H₉ | *—(C═O)O— | —CH₂— |
| CG-15 | n-C₄H₉ | *—(C═O)O— | —(C═O)— |
| CG-16 | CN | Single bond | —CH₂— |
| CG-17 | C₄H₉ | Single bond | —(C═O)— |

For L¹, * represents the bonding position to the cyclohexane ring provided on the left side of the above chemical formula, and — represents a bond.

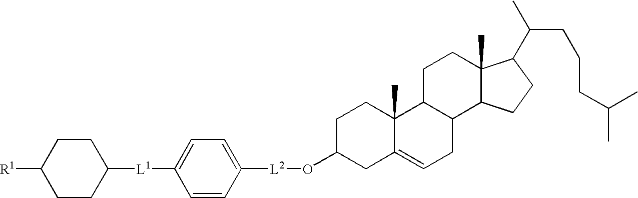

| No. | R¹ | L¹ | L² |
|---|---|---|---|
| CG-18 | n-C₄H₉ | *—(C═O)O— | —CH₂— |
| CG-19 | n-C₄H₉ | *—(C═O)O— | —(C═O)— |
| CG-20 | CN | Single bond | —CH₂— |
| CG-21 | C₄H₉ | Single bond | —(C═O)— |

For L¹, * represents the bonding position to the cyclohexane ring, and — represents a bond.

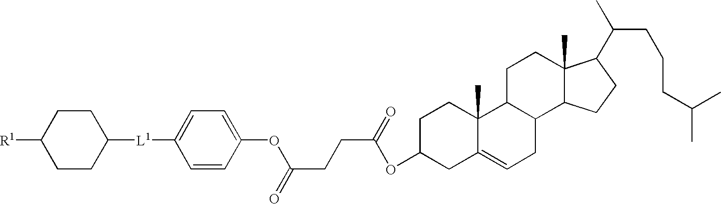

| No. | R¹ | L¹ |
|---|---|---|
| CG-22 | n-C₄H₉ | *—(C═O)O— |
| CG-23 | n-C₄H₉ | Single bond |
| CG-24 | n-C₅H₁₁ | -Ph- |

For L¹, * represents the bonding position to the cyclohexane ring, and — represents a bond.

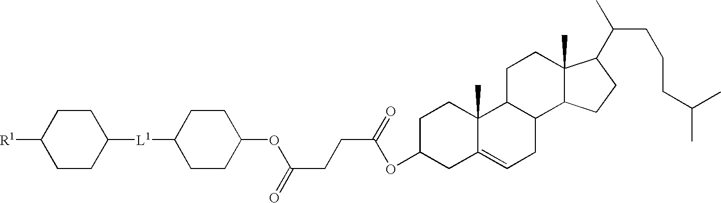

| No. | R¹ | L¹ |
|---|---|---|
| CG-25 | n-C₄H₉ | *—(C═O)O— |
| CG-26 | n-C₄H₉ | Single bond |

For L¹, * represents the bonding position to the cyclohexane ring provided on the left side of the above chemical formula, and — represents a bond.

Preferable combinations of these chiral reagents will be described as follows:
(1) an aromatic ester derivatives and a cholesterol derivatives,
(2) an aromatic ether derivatives and a cholesterol derivatives,
(3) an aliphatic ester derivatives and a cholesterol derivatives,
(4) an aliphatic ether derivatives and a cholesterol derivatives,
(5) a cyclic aliphatic derivatives and a cholesterol derivatives, and
(6) an aromatic ester derivatives and a cyclic aliphatic derivatives.

More preferable combinations are:
(1) an aromatic ester derivatives and a cholesterol derivatives,
(2) an aromatic ether derivatives and a cholesterol derivatives, and
(5) a cyclic aliphatic derivatives and a cholesterol derivatives.

Concerning the mixing ratio between the different types of chiral agents, the content of a cholesterol derivatives chiral reagent with regard to all the chiral reagents is preferably from 10 to 90% by mass, more preferably from 15 to 86% by mass, and even more preferably from 20 to 80% by mass.

When the content of the cholesterol derivatives chiral reagent with regard to the chiral reagents is within the above range, both high display performance and high response speed can be advantageously achieved.

Concerning the display performance of the reflective display material according to the present invention, the ratio of the light reflectance of the material in a white sate to the light reflectance of the material in a colored state (white state/colored state) is preferably within the range of from 3 to 1,000, more preferably from 4 to 500, and particularly preferably from 5 to 100.

(Other Additives)

The liquid crystal composition used for the reflective display material of the present invention may be made to coexist with a polymer. When the reflective display material of the present invention is a method of switching the scattered colored state and a white state, the light modulating material is preferable to be made to coexist with a polymer.

The polymer medium layer, which disperses and contains the liquid crystal composition used for the reflective display material of the present invention, can be formed, for example, by applying the polymer solution, which has dispersed the liquid crystal composition, on the substrate. As for the method of dispersing the liquid crystal composition in the polymer solution, the dispersion can be done by using such means as mechanical stirring, heating, supersonic wave, or the combination.

In the polymer medium layer, the mass ratio of the liquid crystal composition dispersed in the polymer medium to the polymer medium is preferably from 1:10 to 10:1 and more preferably from 1:1 to 8:2.

As the method of forming the polymer medium layer, such methods are preferable that the solution dissolving the polymer and the liquid crystal composition is applied on the substrate, or that a crystal composition liquid and a polymer liquid, which are dissolved in a common solvent, are applied on the substrate, and then the solvent is evaporated.

The polymer used for the polymer medium layer is not particularly restricted. Polymers used include water-soluble polymers such as siloxane polymer, methyl cellulose, polyvinyl alcohol, polyoxyethylene, polyvinyl butyral, and gelatin; polyacrylates, polymethacrylates; polyamides; polyesters; polycarbonates; polyvinyl alcohol derivatives as typified by vinyl acetate and polyvinyl butyral; cellulose derivatives such triacetyl cellulose; and non-water soluble polymer such as polyurethanes and polystyrenes. As a polymer used for the liquid crystal composition and the reflective display element of the present invention, siloxane polymer, polyacrylates, and polymethacrylates are preferable from the viewpoint of high miscibility with the host liquid crystal.

Further, the surfactant can be used in the polymer medium for the purpose of stabilizing the dispersion of the liquid crystal composition. While the surfactant which can be used in the present invention is not particularly restricted, nonionic surfactants are preferable, and sorbitan fatty acid esters, polyoxyethylene fatty acid esters, polyoxyethylene alkyl eters, fluoroalkylethylene oxides, and the like can be used.

Especially, because the dichroic dye related to the present invention has a structure represented by the Formula (1), when a polymer having an aromatic group is used as a polymer, the miscibility of the dichroic dye with the polymer rises, and the reflective display performance can be improved.

In the reflective display material of the present invention, the thickness of the polymer medium layer is preferably from 1 to 50 μm, more preferably from 2 to 40 μm, and further preferably from 5 to 30 μm.

The reflective display material of the present invention may be prepared by mixing different dichroic dyes into a single liquid crystal layer. It may exhibit any color. It may be laminated with an independent liquid crystal layer for exhibiting each color or placed parallel to a liquid crystal layer (liquid crystal part) for exhibiting each color.

Reflective Display Element

The reflective display element of the present invention includes a pair of electrodes at least one of which is a transparent electrode and a liquid crystal layer placed between the pair of electrodes, in which the liquid crystal layer contains the liquid crystal composition described above. If necessary, the reflective display element of the present invention may further include an additional member or material such as a white reflecting plate, an anti-reflection film, or a brightness enhancement film as described below.

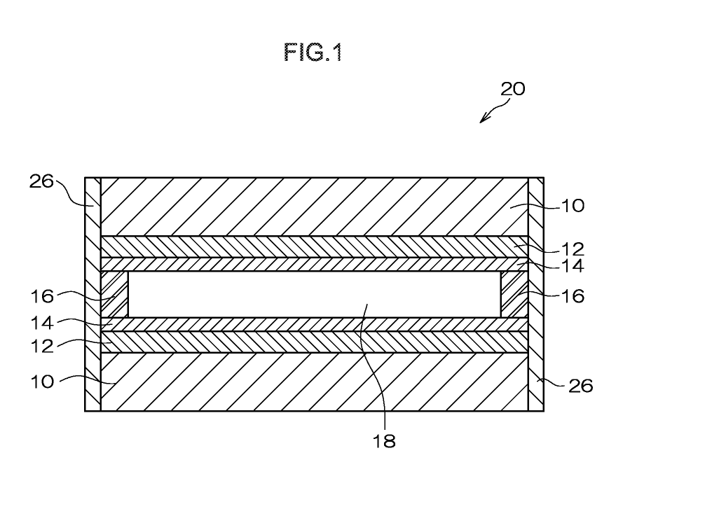

FIG. 1 shows a schematic cross-sectional view showing an example of the reflective display element. In the present exemplary embodiment, a reflective display element 20 includes a pair of substrates (supports) 10 each having a surface provided with a transparent electrode 12; spacers 16 with which the substrates 10 are placed with a space interposed therebetween; and the above-described liquid crystal composition 18 sealed in the space. In FIG. 1, an alignment film 14 is provided on the surface of the transparent electrode 12 facing the liquid crystal composition 18. However, the alignment film 14 is optional. For example, when the liquid crystal composition 18 contains a liquid crystal with dual wavelength addressing property, the alignment film 14 is not necessary. The inlet through which the liquid crystal is injected into the reflective display element 20 is preferably sealed with a sealing agent 26. Although not shown in FIG. 1, the reflective display element may further include an optional member or material as described below.

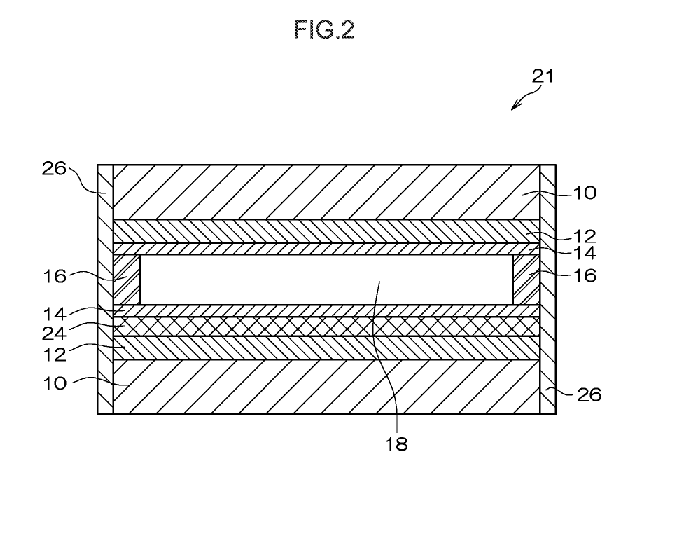

A reflecting layer may also be provided on one of the pair of substrates 10 to form a reflective display element. FIG. 2 is a schematic cross-sectional view showing another example of the reflective display element. In the present exemplary embodiment, a reflective display element 21 has a reflecting layer (white scattering layer) 24 between the transparent electrode 12 and the alignment film 14 provided on one of the substrates 10. The thickness of the reflecting layer 24 is preferably from 2 to 20 μm, and more preferably from 5 to 10 μm. In FIG. 2, the alignment film 14 is optional. For example, when the liquid crystal composition 18 contains a liquid crystal with dual wavelength addressing property, the alignment film 14 is not necessary.

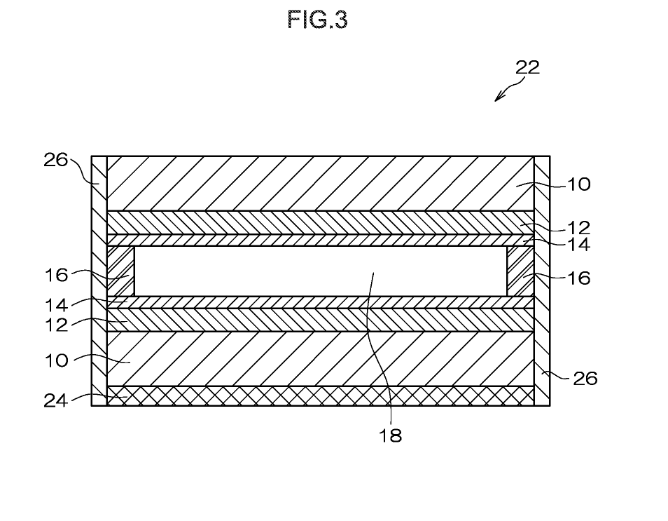

FIG. 3 is a schematic cross-sectional view showing a further example of the reflective display element. In the present exemplary embodiment, a reflective display element 22 has a reflecting layer (white scattering layer) 24 provided on the surface of one of the substrates 10 where the transparent electrode 12 is not provided.

In FIG. 3, the alignment film 14 is optional. For example, when the liquid crystal composition 18 contains a liquid crystal with dual wavelength addressing property, the alignment film 14 is not necessary.

Although not shown in the drawings, a reflecting layer (white scattering layer) 24 may be placed between the substrate 10 and the transparent electrode 12.

The reflective display element of the present invention may be composed by disposing between the pair of electrodes. An electrode substrate used in the reflective display element of the present invention is usually a glass or plastic substrate, and a plastic substrate is preferable. The plastic substrate used in the present invention may be of an acrylic resin, a polycarbonate resin, and an epoxy resin. The practical examples are triacetyl cellulose (TAC), polyethylene terephthalate (PET), polyethylene naphthalate (PEN), syndiotactic polystyrene (SPS), polyphenylene sulfide (PPS), polycarbonate (PC), polyarylate (PAr), polysulfone (PSF), polyester sulfone (PES), polyether imide (PEI), cyclic polyolefin, and polyimide (PI). A preferable polymer is polyethylene terephthalate (PET).

The thickness of the plastic substrate is not particularly limited, and preferably from 30 pm to 700 μm, more preferably from 40 μm to 200 μm, and even more preferably from 50 μm to 150 μm. Further, in any case, the haze is preferably 3% or lower, more preferably 2% or lower, and even more preferably 1% or lower, and the total luminous transmittance is preferably 70% or higher, more preferably 80% or higher, and even more preferably 90% or higher.

The plastic substrate may contain resin property-reforming agents, such as a plasticizer, a dye, a pigment, an antistatic agent, an ultraviolet absorbent, an antioxidant, inorganic fine particles, a release agent, a leveling agent, and a lubricant, as occasion demands, unless the effects of the present invention is impaired.

The plastic substrates may be either light permeable or light impermeable. When a light impermeable support is used as the support, a white support having light reflectivity may be used. Examples of the white substrate include plastic substrates containing inorganic pigments such as titanium oxide or zinc oxide. In the case that the displaying surface is formed by the substrate, the substrate is required to have light permeability to at least the light in the visible range. Detailed description about substrates is made, for example, in “Ekisho Debaisu Handobukku (Liquid Crystal Device Handbook)”, edited by No. 142 Committee of Japan Society for the Promotion of Science, published by the Nikkan Kogyo Shimbun, Ltd., 1989, pages 218 to 231.

An electrode layer is formed on one side of the substrate. Preferably, a transparent electrode layer is formed on at least one side of the substrate. Indium oxide, indium tin oxide (ITO), tin oxide, PEDOT-PSS, silver nanorods, carbon nanotubes, or the like may be used to form the electrode layer. For example, the transparent electrodes described in Japan Society for the Promotion of Science, the 142nd Committee (ed.), Ekisho Device Handbook (Liquid Crystal Device Handbook), NIKKAN KOGYO SHIMBUN, LTD., pp. 232-239 (1989) may be used. The transparent electrode may be formed by a sputtering method, a sol-gel method, or a printing method.

The liquid crystal device of the present invention is preferably provided with a alignment film 14 subjected to an alignment process for the purpose of aligning the liquid crystal, on a surface of the substrate in contact with the liquid crystal. Such alignment process may be a process including applying and aligning a quaternary ammonium salt, a process including applying polyimide and rubbing it to align, a process including vapor depositing SiOₓ from an oblique direction, or an algnment process by light irradiation utilizing photoisomerization. Polyimide, a silane coupling agent, polyvinyl alcohol, gelatin, or the like is preferably used to form the alignment film 14. In view of aligning capability, durability, insulation or cost, polyimide or a silane coupling agent is preferably used. The aligning process may or may not include a rubbing process. The alignment state may be any of a horizontal alignment state and a vertical alignment state.

For example, alignment films disclosed in “Ekisho Debaisu Handobukku (Liquid Crystal Device Handbook)”, edited by No. 142 Committee of Japan Society for the Promotion of Science, published by the Nikkan Kogyo Shimbun, Ltd., 1989, pages 240 to 256 are used as the alignment film.

The reflective display element of the present invention can be manufactured by disposing a pair of substrates so as to face each other with an space of from 1 to 50 μm by the use of spacers or the like, and injecting the liquid crystal composition of the present invention into the space. The spacer is described, for example, from pages 257 to 262 of Liquid Crystal Device Handbook, edited by Committee 142 of Japan Society for the Promotion of Science, Nikkan Kogyo Shimbunsha, 1989. The liquid crystal composition of the present invention can be disposed in the space between the substrates by applying or printing the liquid crystal composition on the substrate.

—Other Members—

Other members include, for instance, a barrier film, an ultraviolet absorption layer, an antireflection layer, a hard court layer, a fouling prevention layer, an insulating film between organic layers, a metallic reflecting plate, and a phase difference plate. One of them may be used alone, or two or more of them may be used in combination.

Any film of organic polymer-based compounds, inorganic compounds, and organic-inorganic complexes is acceptable as the barrier film. The organic polymers include ethylene-vinyl alcohol (EVOH), polyvinyl alcohol (PVA/PVOH), nylon MXD6 (N-MXD), and nano-composite-based nylons. The inorganic compounds include silica, alumina, and binary systems. The details have been described in, for example, “Development of high barrier materials, film forming technology, and barrier property measurement and evaluation method” (Technical Information Institute Co., Ltd., 2004).

In the reflective display material of the present invention, it is preferable to place the barrier layer on the surface of the support where a transparent electrode is not placed from the viewpoint of easiness of manufacturing.

The ultraviolet absorption layer is preferable to contain an antioxidant such as 2,2-thiobis(4-methyl-6-t-butylphenol) and 2,6-di-t-butylphenol, and an ultraviolet absorbent such as 2-(3-t-butyl-5-methyl-2-hydroxyphenyl)-5-chlorobenzotriazole and alkoxybenzophenone.

In the reflective display material of the present invention, it is preferable to place the ultraviolet absorption layer on the surface of the support where a transparent electrode is not placed from the viewpoint of easiness of manufacturing.

The antireflection film is formed by using an inorganic material or an organic material, and the film constitution may be a single layer or may be a multilayer. In addition, it may be an inorganic-organic composite film in which the multilayer structure is made with the film of an inorganic material and the film of an organic material. The antireflection film can be installed on one side or both sides of the reflective display element. When being installed on both sides, the antireflection films on both sides may have the same constitution, and may respectively have different constitution. For example, it is also possible to make the antireflection film on one side a multilayer structure, and to simplify the antireflection film on the other side to a single layer structure. Moreover, the antireflection film can be installed directly on a transparent electrode or on the support.

Inorganic materials used for the antireflection film include SiO₂, SiO, ZrO₂, TiO₂, TiO, Ti₂O₃, Ti₂O₅, Al₂O₃, Ta₂O₅, CeO₂, MgO, Y₂O₃, SnO₂, MgF₂, and WO₃. These can be used alone or using two or more kinds in combination. Among these materials, it is preferable to use SiO₂, ZrO₂, TiO₂, and Ta₂O₅ that vacuum deposition is possible at low temperature.

As a multilayer film formed with inorganic materials, the laminated structure where the high refractive index material layer and the low refractive index material layer are formed alternately from the support side is illustrated, that is, from the support side, the total optical film thickness of the ZrO₂ layer and the SiO₂ layer is λ/4, the optical film thickness of the ZrO₂ layer is λ/4, and the optical film thickness of the SiO₂ layer which is the most surface layer is λ/4. Herein, λ is the design wavelength, and usually 520 nm is used. The most surface layer is preferably SiO₂ because it has a low refractive index and can give mechanical strength to the antireflection film. When the antireflection film is formed with an inorganic material, the film forming method can adopt, for example, a vacuum deposition method, an ion plating method, a sputtering method, a CVD method, a precipitating method in saturated solution by chemical reaction, and the like.

Organic materials used for the antireflection film include, for example, FFP (tetrafluoroethylene-hexafluoropropylene copolymer), PTFE (polytetrafluoroethylene), and ETFE (ethylene-tetrafluoroethylene copolymer). As for the film forming method, besides a vacuum deposition method, the film can be formed by the use of painting methods such as a spin coating method and a dip coating method that are excellent in mass production.

As a hard court layer, well-known ultraviolet curing or electron beam curing acrylic-based resins or epoxy-based resins can be used.

As a fouling prevention layer, water-repellent and oil-repellent materials like a fluorine-containing organic polymer can be used.

A resin for forming a reflective layer 24 may be used known resins, for example, an acrylic resin, a methacrylic resin such as polymethyl methacrylate, a polystyrene, a polyester, polyethylene, a polypropylene, a polycarbonate, a polyacrylonitrile, a polyethylene oxide, a polyvinyl pyrrolidone, a polysulfone, a polydimethyl siloxane, a polyvinyl alcohol, a gelatin, a cellulose, a copolymer thereof, or a mixture thereof. Preferable resins is a mixture of an acryl resin or methacryl resin such as polymethyl methacrylate and a polyvinyl pyrrolidone or a cyanoethylated cellulose (manufactured by Shin-Etsu Chemical Co., Ltd.), from the viewpoint of a transparency of the resin and a dispersibility of titanium dioxide thereto.

The reflective layer 24 is preferably formed by resin dispersed a white pigment. Examples of the white pigment include an inorganic pigment such as a silica dioxide, a titanium dioxide, a barium sulfate, a barium titanate, a lithopone, an aluminum oxide, a calcium carbonate, a silicon oxide, an antimony trioxide, a titanium phosphate, a zinc oxide, a white lead, or a zirconium oxide; and an organic powder such as a polystyrene, styrene-divinylbenzene copolymer.

Among these pigments, it is preferable to use a titanium dioxide, an aluminum oxide or a barium titanate, and a titanium dioxide is particularly effective. The titanium dioxide may be a rutile type or an anatase type. An anatase type is preferable when prioritizing whiteness, and a rutile type is preferable when prioritizing the covering. In view of both whiteness and sharpness, a rutile type and an anatase type may be blended. These titanium dioxides may be produced by a sulfate method or a chloride method.

Specific examples of titanium dioxide include JR, JRNC, JR-301, 403, 405, 600A, 605, 600E, 603, 701, 800, 805, 806, JA-1, C,3,4,5, MT-01, 02, 03, 04, 05, 100AQ, 100SA, 100SAK, 100SAS, 100TV, 100Z, 100ZR, 150W, 500B, 500H, 500SA, 500SAK, 500SAS, 500T, SMT-100SAM, 100SAS, 500SAM, 500SAS (all of which are manufactured by TAYCA CORPORATION); CR-50, 50-2, 57, 58, 58-2, 60, 60-2, 63, 67, 80, 85, 90, 90-2, 93, 95, 97, 953, Super70, PC-3, PF-690, 691, 711, 736, 737, 739, 740, 742, R-550, 580, 630, 670, 680, 780, 780-2, 820, 830, 850, 855, 930, 980, S-305, UT771, TTO-51(A), 51(C), 55(A), 55(B), 55(C), 55(D), S-1, S-2, S-3, S-4, V-3, V-4, MPT-136, FTL-100, 110, 200, 300 (all of which are manufactured by ISHIHARA SANGYO KAISHA LTD.); KA-10, 15, 20, 30, KR-310, 380, KV-200, STT-30EHJ, 65C-S, 455, 485SA15, 495M, 495MC (all of which are manufactured by Titan Kogyo); TA-100, 200, 300, 400, 500, TR-600, 700, 750, 840, 900 (all of which are manufactured by Fuji Titium Industry Co., Ltd.), and these titanium dioxide may be used alone or in combination.

In order to improving dispersibility in the resin, a white pigment may be treated by known material such as a silane coupling agent having an amino group, a glycidyl group, an ureide group, an isocyanate group, a mercapto group, a vinyl group, an allyl group, an acryloxy group, a methacryloxy, a styryl group as a functional group.

A mass ratio of a mixture of the resin and white pigment is preferably with in the range of from 90/10 to 30/70 (resin/white pigment), more preferably from 80/20 to 40/60, and furthermore preferably from 70/30 to 40/60.

The reflective layer 24 preferably contains a fluorescent whitening agent. Examples of the fluorescent whitening agent include a benzoxazole-based, a coumalin-based, a pyrazoline-based, or a styrenebiphenyl derivative, and preferably benzoxazolyl naphthalene-based, benzooxazolyl stilbene-based, or benzooxazolyl thiophene-based.

The content of the fluorescent whitening agent in the reflective layer 24 is from 0.1% to 10% by mass, preferably from 0.1% to 5% by mass, and more preferably from 0.1% to 3.0% by mass.

The reflective layer 24 may be formed by coating a resin solution dispersing a white pigment, additionally blending a fluorescent whitening agent. Examples of coating methods includes known methods such as a blade coater, an air doctor coater, a rod coater, a knife coater, a squeeze coater, a dip coater, a reverse roll coater, a transfer roll coater, a gravure coater, a kiss roll coater, a cast coater, a spray coater, a curtain coater, a extrusion coater. For details, “Coating engineering” written by YUJI HARASAKI may be refer to.

Examples of solvents for the resin solution include water, methanol, ethanol, isopropyl alcohol, acetone, methylethylketone, tetrahydrofuran, ethyl acetate, butyl acetate, hexane, toluene, acetonitrile, γ-butyllactone, N-methylpyrolidone, N-dimethyl acetoamide, or dimethylsulfoxide, and preferably butyl acetate, N-methylpyrolidone or N-dimethyl acetoamide, from the viewpoint of the low volatile and the high solubility for the resin.

Examples of dispersing methods of the resin solution include a vibration mill, a roll mill, a ball mill, a beads mill, a paint shaker or a homogenizer, preferably a roll mill, a ball mill or a beads mill from the viewpoint of the high dispersibility of the pigments.

After coating the resin solution by the above method, heating and drying are performed in order to eliminate the solvent. The temperature and time for heating is adjusted as necessary depending on the kind or the volume of the solvent used.

The resin solution may be directly coated on the substrate 10, or the resin solution may be coated on a film (for example, PET) and the coated film may be adhered to the substrate 10.

Alternatively, the reflective layer 24 may be produced by a fusion casting method with a colored resin which is made by kneading a thermoplastic resin, a white pigment and a fluorescent whitening agent with a roll mill or a kneader (extruder) while heating at above the glass transition temperature of the resin. When fusion casting, the reflective layer may be formed as a film on a base film. The reflective layer may be produced by other methods without being limited to the above method.

Alternatively, a synthetic paper such as ULTRA YUPO, SUPER YUPO, NEW YUPO, ALFA YUPO (registered, all of which are manufactured by YUPO CORPORATION) may be used as a reflective layer. In order to improving a reflectance, a metal foil, a film adhering a metal foil or a metal vapor deposition film may be adhered under the reflective layer containing a white pigment. Specific examples of metal for the reflective layer include known metal such as aluminum, silver, silver alloy, platinum, chromium, or stainless. These metal may be used as a single layer or an accumulated layer. From the viewpoint of high reflectance, it is preferable to use aluminum, silver or silver alloy.

A luminous reflectance (Y value) of the reflective layer 24 is preferably from 60% to 100% from the viewpoint of enhancing a reflectance of a display device, more preferably from 70% to 100%, and furthermore preferably from 80% to 90%. The luminous reflectance (Y value) is defined as a reflectance rate measured by integrating sphere measurement, when a standard white plate is calibrated at 100% using a spectrophotometer, in which the specular reflection is not included.

A whiteness of the reflective layer 24, which is measured by ASTM E313, is preferably from 60 to 120, more preferably from 80 to 120, and furthermore preferably 90 to 120.

A luminous reflectance (Y value) of the reflective display device is preferably from 10% to 100% from the viewpoint of enhancing a contrast of a display device, more preferably from 20% to 100%, and furthermore preferably from 40% to 100%.

A whiteness of the reflective display device is preferably from 10 to 120, more preferably from 20 to 120, and furthermore preferably 30 to 120.

The reflective display element of the present invention may be driven by a simple matrix driving system, or by an active matrix driving system utilizing a thin film transistor (TFT) or the like. For example, driving systems disclosed in “Ekisho Debaisu Handobukku (Liquid Crystal Device Handbook)”, edited by No. 142 Committee of Japan Society for the Promotion of Science, published by the Nikkan Kogyo Shimbun, Ltd., 1989, pages 387 to 460 are used as the driving system.

The reflective display element using the liquid crystal composition of the present invention may be in any system, examples of available systems include (1) homogeneous alignment and (2) homeotropic alignment, both being classified in the guest-host system described in “Ekisho Debaisu Handobukku (Liquid Crystal Device Handbook)”, edited by No. 142 Committee of Japan Society for the Promotion of Science, published by the Nikkan Kogyo Shimbun, Ltd., 1989, page 309; (3) focalconic alignment and (4) homeotropic alignment, both being classified in White-Taylor type (phase transition); (5) combination with Super Twisted Nematic (STN); (6) combination with ferroelectric liquid crystal (FLC); and (1) Heilmeier type GH mode, (2) quarter-wave plate type GH mode, (3) double layer type GH mode, (4) phase transition type GH mode, and (5) polymer-dispersed liquid crystal (PDLC) type GH mode disclosed in “Hansha-gata Kara LCD Sogo Gijutsu (General Technologies of Reflection-type Color LCD)”, supervised by Tatsuo Uchida, published by CMC, 1999, Chapter 2-1 “GH-mode, Reflective Type Color LCD”, pages 15 to 16. In particular, White-Taylor type (phase transition) is preferable in the present invention.

The liquid crystal device may employ known driving methods such as a (1) segment driving using 7 segments and a dot-matrix, (2) passive matrix driving using a stripe electrode, and (3) active matrix driving using a TFT element or a TFD element. The gradation display method may use known modulation methods such as a pulse width modulation method or a frame modulation method, and may be combined with overdrive driving as appropriate.

The reflective display element of the present invention can be used for the layered GH mode disclosed in JP-A Nos. 10-67990, 10-239702, 10-133223, 10-339881, 11-52411, 11-64880, 2000-221538, or the like., and for the GH mode utilizing microcapsules disclosed in JP-A No. 11-24090, or the like.

It can be used also for reflective liquid crystal display such as those disclosed in JP-A Nos. 6-235931, 6-235940, 6-265859, 7-56174, 9-146124, 9-197388, 10-20346, 10-31207, 10-31216, 10-31231, 10-31232, 10-31233, 10-31234, 10-82986, 10-90674, 10-111513, 10-111523, 10-123509, 10-123510, 10-206851, 10-253993, 10-268300, 11-149252, 2000-2874, or the like.

It can be used also for the polymer-dispersed liquid crystal type GH mode disclosed in JP-A Nos. 5-61025, 5-265053, 6-3691, 6-23061, 5-203940, 6-242423, 6-289376, 8-278490, and 9-813174.

Preferred driving methods are further described below.

In some cases, hysteresis exists in a phase transition liquid crystal display element, when the phase changes between a cholesteric phase and a nematic phase. In such cases, a selection electric potential for determining the phase of the transition liquid crystal may be applied simultaneously with a voltage for stabilizing the phase, so that the hysteresis can be reduced. In general, the voltage for stabilizing the phase is preferably a short pulse AC voltage.

A method including applying energy greater than the variation width for the target display density and then applying smaller energy to achieve the desired display density is preferably used to efficiently achieve half-tone display in the reflective display element. The energy amount may be controlled by any of a method of controlling the applied voltage and a method of controlling the time of the application.

A method including placing an optical sensor in the display element to get feedback on whether the desired display density is achieved and controlling the applied energy based on the feedback is also preferably used to efficiently achieve half-tone display in the reflective display element.

A method including temporarily turning the display into an entirely colored state or an entirely white state when the display is changed and then applying energy for the desired display density is preferably used to stabilize the display performance.

A driving method including forming a pixel switching element and a driving circuit for applying a signal to the pixel switching element on the same substrate may also be used to stabilize the display performance. In this case, the source voltage applied to the pixel switching element may be set smaller than the source voltage applied to the driving circuit for applying a signal to the pixel switching element, so that stable driving can be achieved.

Applications

The reflective display element of the present invention has the advantageous effect that high display contrast and high response speed are achieved.

Since the colored scattered state can be kept in a state that no voltage is applied when the dielectric constant anisotropy of the liquid crystal is negative in the reflective display element of the present invention, there are brought advantages that (1) the consumed electric power can be reduced so that a load is not applied to the environment; and (2) the deterioration of the liquid crystal device can be suppressed so that a lifetime can be prolonged. Accordingly, the liquid crystal device of the present invention is able to decrease the battery capacity and is applicable to main-display or sub-display of mobile appliances such as a digital camera, a wrist watch, a mobile phone or an electronic music device.

The liquid crystal device may be also used for the main-display or sub-display of an electronic inventory tag, an electronic musical instrument, a clock, an electronic book, an electronic dictionary or the like.

### Example

The present invention will be described more specifically citing example as follows. Materials, reagents, the amount of substances and the ratio, operations and the like shown in the following examples can be properly changed as long as being not deviated from the purport of the present invention. Therefore, the range of the present invention should not be limited to the following specific examples.

### Example 1

### Preparation of Reflective Display Elements

Anthraquinone dyes according to the present invention were synthesized according to known methods (e.g., the methods described in Alexander V. Ivashchenko, DICHROIC DYES for LIQUID CRYSTAL DISPLAYS (CRC Press)). The structure was confirmed using H¹-NMR and mass spectrometry. A host liquid crystal and chiral reagents were purchased from Merck. Commercially unavailable materials were synthesized based on known methods.

Preparation of Chiral Reagent-Containing Liquid Crystal Compositions

A chiral reagent or reagents were added to the host liquid crystal MLC-6609 (trade name), and then the transition temperature (Tᵢₛₒ) at which the liquid crystal changed from a nematic phase to an isotropic phase was evaluated. The results are shown in Table 1.

TABLE 1

| | Content | Tᵢₛₒ | ΔT | |
|---|---|---|---|---|
| Chiral reagent | (% by mass) | (° C.) | (° C.) | Note |
| Absent | — | 100 | — | Basic composition |
| CA-1:CG-7 | 1:1 | 105 | +5 | Invention |
| CA-1:CG-7 | 1:2 | 104 | +4 | Invention |
| CA-1:CG-7 | 2:1 | 105 | +5 | Invention |
| CA-1:CA-8 | 1:1 | 103 | +3 | Invention |
| CA-1:CF-1 | 1:1 | 102 | +2 | Invention |
| CA-1:CG-1 | 1:1 | 103 | +3 | Invention |
| CG-7:CF-1 | 1:1 | 103 | +3 | Invention |
| CA-8:CG-7 | 1:1 | 105 | +5 | Invention |
| CB-4:CG-7 | 1:1 | 105 | +5 | Invention |
| CE-1:CG-7 | 1:1 | 105 | +5 | Invention |
| CA-1 | 2 | 100 | 0 | Comparative example |
| CA-8 | 2 | 100 | 0 | Comparative example |
| CG-7 | 2 | 101 | +1 | Comparative example |
| CF-1 | 2 | 100 | 0 | Comparative example |

ΔT: a change rate in the Tᵢₛₒ with regard to MLC-6609

Table 1 shows that the transition temperature (Tᵢₛₒ) at which the host liquid crystal MLC-6609 in the composition changes from a nematic phase to an isotropic phase tends to be higher in the case of the composition containing two chiral reagents according to the present invention.

Preparation of Liquid Crystal Elements for Reflective Display

Liquid crystal compositions were prepared by mixing the anthraquinone dyes and the chiral reagents shown in Tables 2 and 3 below with the host liquid crystal (trade name: MLC-6609, manufactured by Merck), respectively. The dye concentration was adjusted so that a luminous reflectance of 60% could be obtained for white when no voltage was applied. The content of each chiral reagent was adjusted so that the chiral pitch of the liquid crystal composition could be the value shown in the table below.

A vertical alignment film (trade name: SE-5300, manufactured by NISSAN CHEMICAL INDUSTRIES, LTD.) was applied to each of two ITO glass substrates (manufactured by EHC) and baked. A cell was prepared by placing polystyrene spacers (manufactured by SEKISUI CHEMICAL CO., LTD.) between the two ITO glass substrates so that a cell gap of 8 μm could be obtained.

Each of the liquid crystal compositions was injected into the cell, and a white scattering plate (manufactured by YUPO CORPORATION) was provided on the back surface of the glass substrate on the non-display side.

Y-1, M-1 and C-1 shown below were each used as a dye for comparison.

Evaluation of Reflectance, Contrast Ratio and Response Speed

The prepared liquid crystal element displayed exhibited white when no voltage was applied. In this state, the luminous reflectance was measured with a spectrophotometer (trade name: UV-3100PC, manufactured by Shimadzu Corporation). As a result, the luminous reflectance of each of samples 1 to 11 was 60%, when the reflectance of a standard white plate was normalized as 100% by an integrating sphere method excluding specular reflection.

When a rectangular-wave AC voltage of 10 V (80 Hz in frequency) was applied from a signal generator (manufactured by TEKTRONIX, INC.) to the prepared liquid crystal element, the liquid crystal element exhibited black. At this time, the luminous reflectance was measured. The ratio (the contrast ratio) of the luminous reflectance for the white display to the luminous reflectance for the black display is shown together with the response speed upon the application of the voltage (the time required for the concentration to change by 90%) in Tables 2 and 3 below.

TABLE 2

| | | | | | | Re- | |
|---|---|---|---|---|---|---|---|
| | | Chiral reagent | | Chiral | Con- | sponse | |
| Sam- | | | Mixing ratio | pitch | trast | speed | |
| ple | Dye | Type | (mass ratio) | (μm) | ratio | (ms) | Note |
| 1 | A-1 | CA-8 | 1:1 | 8 | 7.0 | 120 | Inven- |
| | B-1 | CG-7 | | | | | tion |
| | C-1 | | | | | | |
| | D-1 | | | | | | |
| 2 | A-1 | CA-1 | 1:1 | 8 | 6.9 | 120 | Inven- |
| | B-1 | CG-7 | | | | | tion |
| | C-1 | | | | | | |
| | D-1 | | | | | | |
| 3 | A-8 | CA-1 | 1:1 | 8 | 7.2 | 120 | Inven- |
| | B-1 | CG-16 | | | | | tion |
| | C-1 | | | | | | |
| | D-1 | | | | | | |
| 4 | A-8 | CA-1 | 1:1 | 8 | 7.2 | 120 | Inven- |
| | B-1 | CG-7 | | | | | tion |
| | C-1 | | | | | | |
| | D-11 | | | | | | |
| 5 | A-8 | CA-1 | 1:1 | 12 | 6.7 | 100 | Inven- |
| | B-1 | CG-7 | | | | | tion |
| | C-1 | | | | | | |
| | D-11 | | | | | | |
| 6 | A-8 | CA-1 | 1:2 | 12 | 6.5 | 110 | Inven- |
| | B-1 | CG-7 | | | | | tion |
| | C-1 | | | | | | |
| | D-11 | | | | | | |
| 7 | A-8 | CA-1 | 2:1 | 12 | 6.7 | 120 | Inven- |
| | B-1 | CG-7 | | | | | tion |
| | C-1 | | | | | | |
| | D-11 | | | | | | |
| 8 | A-8 | CA-1 | 1:1 | 7 | 7.3 | 120 | Inven- |
| | B-1 | CG-7 | | | | | tion |
| | C-1 | | | | | | |
| | D-11 | | | | | | |
| 9 | A-8 | CA-1 | 1:1:1 | 8 | 7.2 | 120 | Inven- |
| | B-1 | CC-2 | | | | | tion |
| | C-1 | CG-7 | | | | | |
| | D-11 | | | | | | |
| 10 | A-8 | CB-4 | 1:1 | 8 | 7.0 | 110 | Inven- |
| | B-1 | CG-7 | | | | | tion |
| | C-1 | | | | | | |
| | D-11 | | | | | | |
| 11 | A-8 | CE-1 | 1:1 | 8 | 7.2 | 120 | Inven- |
| | B-1 | CG-7 | | | | | tion |
| | C-1 | | | | | | |
| | D-11 | | | | | | |

TABLE 3

| | | | | | | Re- | |
|---|---|---|---|---|---|---|---|
| | | Chiral reagent | | Chiral | Con- | sponse | |
| Sam- | | | Mixing ratio | pitch | trast | speed | |
| ple | Dye | Type | (mass ratio) | (μm) | ratio | (ms) | Note |
| 12 | A-1 | CA-8 | — | 8 | 5.5 | 140 | Compar- |
| | B-1 | | | | | | ative |
| | C-1 | | | | | | example |
| | D-1 | | | | | | |
| 13 | A-1 | CG-7 | — | 8 | 5.7 | 150 | Compar- |
| | B-1 | | | | | | ative |
| | C-1 | | | | | | example |
| | D-1 | | | | | | |
| 14 | Y-1 | CA-8 | 1:1 | 8 | 4.0 | 180 | Compar- |
| | M-1 | CG-7 | | | | | ative |
| | C-1 | | | | | | example |
| 15 | Y-1 | CA-1 | 1:1 | 8 | 4.1 | 180 | Compar- |
| | M-1 | CG-7 | | | | | ative |
| | C-1 | | | | | | example |
| 16 | Y-1 | CA-8 | — | 8 | 3.9 | 180 | Compar- |
| | M-1 | | | | | | ative |
| | C-1 | | | | | | example |

Structure of Dyes for Comparison is shown below.

### Comparative Example 1

Conventional compounds described in Jpn. J. Appl. Phys. vol. 37, 3422 (1998).

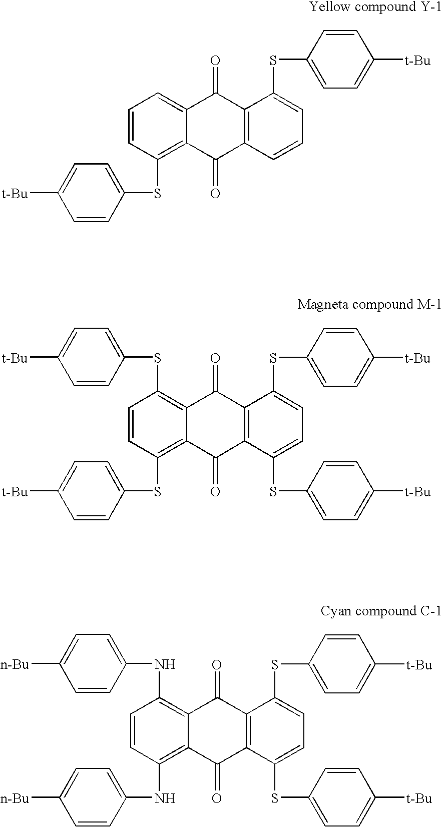

Tables 2 and 3 show that each of samples 1 to 11 according to the present invention has a high contrast ratio and a high response speed.

Example 2

Liquid crystal compositions were prepared by adding the dyes and the chiral reagents shown in Tables 4 and 5 to a host liquid crystal (trade name: MLC-15900-100, manufactured by Merck), respectively.

A horizontal alignment film (trade name: SE-130, manufactured by NISSAN CHEMICAL INDUSTRIES, LTD.) was applied to each of two ITO glass substrates (manufactured by EHC) and baked. A cell was prepared by placing polystyrene spacers (manufactured by SEKISUI CHEMICAL CO., LTD.) between the two ITO glass substrates so that a cell gap of 8 μm could be obtained. Each of the liquid crystal compositions was injected into the cell, and a white scattering plate (manufactured by YUPO CORPORATION) was provided on the back surface of the glass substrate on the non-display side. The dye concentration was adjusted so that a luminous reflectance of 60% could be obtained for white when no voltage was applied. The content of each chiral reagent was adjusted so that the chiral pitch of the liquid crystal composition could be the value shown in the table below.

Y-1, M-1 and C-1 shown above were each used as a dye for comparison.

Evaluation of Reflectance and Contrast

The prepared liquid crystal element exhibited black when no voltage was applied. In this state, the luminous reflectance was determined with a spectrophotometer (trade name: UV-3100PC, manufactured by Shimadzu Corporation), while the reflectance of a standard white plate was normalized as 100% by an integrating sphere method excluding specular reflection.

When a rectangular-wave AC voltage of 10 V (80 Hz in frequency) was applied from a signal generator (manufactured by TEKTRONIX, INC.) to the prepared liquid crystal element, the liquid crystal element exhibited white. At this time, the luminous reflectance was measured. The ratio of the luminous reflectance for the white display to the luminous reflectance for the black display (the contrast ratio) is shown together with the response speed upon the application of the voltage (the time required for the concentration to change by 90%) in Tables 4 and 5 below.

TABLE 4

| | | | | | | Re- | |
|---|---|---|---|---|---|---|---|
| | | Chiral reagent | | Chiral | Con- | sponse | |
| Sam- | | | Mixing ratio | pitch | trast | speed | |
| ple | Dye | Type | (mass ratio) | (μm) | ratio | (ms) | Note |
| 17 | A-1 | CA-8 | 1:1 | 8 | 6.5 | 120 | Inven- |
| | B-1 | CG-7 | | | | | tion |
| | C-1 | | | | | | |
| | D-1 | | | | | | |
| 18 | A-1 | CA-1 | 1:1 | 8 | 6.4 | 120 | Inven- |
| | B-1 | CG-7 | | | | | tion |
| | C-1 | | | | | | |
| | D-1 | | | | | | |
| 19 | A-8 | CA-1 | 1:1 | 8 | 7.2 | 120 | Inven- |
| | B-1 | CG-16 | | | | | tion |
| | C-1 | | | | | | |
| | D-1 | | | | | | |
| 20 | A-8 | CA-1 | 1:1 | 8 | 6.8 | 120 | Inven- |
| | B-1 | CG-7 | | | | | tion |
| | C-1 | | | | | | |
| | D-11 | | | | | | |
| 21 | A-8 | CA-1 | 1:1 | 12 | 6.3 | 100 | Inven- |
| | B-1 | CG-7 | | | | | tion |
| | C-1 | | | | | | |
| | D-11 | | | | | | |
| 22 | A-8 | CA-1 | 1:1 | 7 | 6.9 | 120 | Inven- |
| | B-1 | CG-7 | | | | | tion |
| | C-1 | | | | | | |
| | D-11 | | | | | | |
| 23 | A-8 | CA-1 | 1:1:1 | 8 | 6.8 | 120 | Inven- |
| | B-1 | CC-2 | | | | | tion |
| | C-1 | CG-7 | | | | | |
| | D-11 | | | | | | |

TABLE 5

| | | | | | | Re- | |
|---|---|---|---|---|---|---|---|
| | | Chiral reagent | | Chiral | Con- | sponse | |
| Sam- | | | Mixing ratio | pitch | trast | speed | |
| ple | Dye | Type | (mass ratio) | (μm) | ratio | (ms) | Note |
| 24 | A-1 | CA-8 | — | 8 | 4.9 | 140 | Compar- |
| | B-1 | | | | | | ative |
| | C-1 | | | | | | example |
| | D-1 | | | | | | |
| 25 | A-1 | CG-7 | — | 8 | 5.0 | 150 | Compar- |
| | B-1 | | | | | | ative |
| | C-1 | | | | | | example |
| | D-1 | | | | | | |
| 26 | Y-1 | CA-8 | 1:1 | 8 | 3.8 | 180 | Compar- |
| | M-1 | CG-7 | | | | | ative |
| | C-1 | | | | | | example |
| 27 | Y-1 | CA-1 | 1:1 | 8 | 3.9 | 180 | Compar- |
| | M-1 | CG-7 | | | | | ative |
| | C-1 | | | | | | example |
| 28 | Y-1 | CA-8 | — | 8 | 3.5 | 180 | Compar- |
| | M-1 | | | | | | ative |
| | C-1 | | | | | | example |

Tables 4 and 5 show that each of samples 17 to 23 according to the present invention has a high contrast ratio and a high response speed.

### Example 3

### Preparation of Three-Layer Reflective Display Material

A soluble polyimide (trade name: JALS-682-R3, manufactured by JSR Corporation) for forming a vertical alignment film was applied to a glass substrate having one side coated with an ITO transparent electrode and to the ITO transparent electrode of a glass substrate having both sides coated with the ITO transparent electrode, and baked and then subjected to a rubbing process.

Two pieces of the glass substrates each having both sides coated with the ITO transparent electrode were placed between two pieces of the glass substrates each having one side coated with the ITO transparent electrode with 8 μm spacers interposed between them, and the glass substrates were placed in such a manner that the respective alignment films could be opposed to one another, so that a cell having a laminated structure with three layered spaces was obtained. The direction of each substrate was controlled so that the rubbing directions of each pair of the opposed alignment film surfaces could be anti-parallel to each other.

The specific yellow dye A-1, the specific cyan dye D-2 and the specific magenta dye C-13 were each dissolved in a mixture of a host liquid crystal (trade name: MLC-6608, manufactured by Merck) and chiral reagents CA-8 and CG-7 (1:1 in mass ratio), so that guest-host liquid crystal compositions were obtained. The dye A-1-containing liquid crystal composition were injected into the uppermost layer space, the dye D-2-containing liquid crystal composition were injected into the second layer space, and the dye C-13-containing liquid crystal composition were injected into the lowermost layer space of the cell with the laminated structure by a vacuum injection method. The dye concentration was adjusted so that a luminous reflectance of 60% could be obtained for white. The content of each chiral reagent was adjusted so that the liquid crystal composition could have a chiral pitch of 8 μm.

A comparative sample was prepared using Y-1, M-1 and C-1 as comparative dyes.

A white scattering plate (manufactured by YUPO CORPORATION) was then bonded to the cell with an adhesive, and a low reflection layer (optical-interference thin film consisting of three layer) was attached to the main surface of the uppermost transparent substrate on the light input side (the front end face viewed from the image display side) for preventing a surface reflection-induced reduction in contrast, so that a guest-host reflective liquid crystal element having a three-layer structure was obtained.

Evaluation of Reflectance, Contrast and Response Speed

The luminous reflectance and the contrast ratio were determined by the same method as in Example 1. As a result, the luminous reflectance of the white display side (during the transparent state) was 50%, and the luminous reflectance of the black display side (during the colored state) was 5%. Therefore, the contrast ratio (the luminous reflectance of the white display/the luminous reflectance of the black display) was 10. On the other hand, the contrast ratio (the luminous reflectance of the white display/the luminous reflectance of the black display) of the comparative sample was 5.5.

The response speed was 120 ms as measured by the same method as that in Example 1.

The guest-host reflective liquid crystal element of Example 3 having a three-layer structure had a high contrast ratio and a high response speed.

It was confirmed that the yellow, magenta and cyan layers in the guest-host reflective liquid crystal element of Example 3 was capable of being driven independently, thus the guest-host reflective liquid crystal element of Example 3 achieved full color display.

### Example 4

Preparation of Reflective Liquid Crystal Element with Film Substrate

Preparation of Plastic Substrate

An undercoat layer and a backing layer were formed on PEN (trade name: Q65A, DuPont-Teijin) in the same manner as in the preparation of sample 110 of Example 1 disclosed in JP-A No. 2000-105445. Specifically, 100 parts by mass of a polyethylene-2,6-naphthalate polymer and 2 parts by mass of an ultraviolet-absorbing agent (trade name: Tinuvin P-326, manufactured by Ciba-Geigy Corporation) were dried and then molten at 300° C. The melt was then extruded from a T die and longitudinally stretched 3.3 times at 140° C. and then transversely stretched 3.3 times at 130° C. The product was then thermally fixed at 250° C. for 6 seconds, so that a 90 μm thick plastic substrate (PEN) according to the present invention was obtained.

Preparation of Transparent Electrode Layer

One side of the resulting plastic substrate was coated with electrically-conductive indium tin oxide (ITO), so that a 200 nm thick uniform thin film was formed on the substrate. The surface resistance was about 20 Ω/cm², and the light transmittance (500 nm) was 85%.

A SiO₂ thin film (100 nm) was then formed as an anti-reflection film on the ITO surface by sputtering. The light transmittance (500 nm) was 90%. A white scattering plate (manufactured by YUPO CORPORATION) was further bonded to the electrode-free surface with an adhesive.

Preparation of Liquid Crystal Layer

Using the support described above, a liquid crystal layer was prepared by the same process as that for sample 1 in Example 1.

Formation of Barrier Layer Formation of Organic-Inorganic Hybrid Layer

Eight g of Soarnol D2908 (the trade name of an ethylene-vinyl alcohol copolymer, manufactured by The Nippon Synthetic Chemical Industry Co., Ltd.) was dissolved in a mixed solvent of 118.8 g of 1-propanol and 73.2 g of water at 80° C., and 2.4 ml of 2 N hydrochloric acid was added to 10.72 g of the resulting solution and mixed. Under stirring, 1 g of tetraethoxysilane was added dropwise to the solution, and the stirring was continued for 30 minutes.

The resulting coating liquid was then applied onto the support with a wire bar. The coating was then dried at 120° C. for 5 minutes, so that an about 1 μm thick organic-inorganic hybrid layer was formed.

Formation of Ultraviolet-Absorbing Layer

A mixture of 42 g of water, 40 g of silanol-modified polyvinyl alcohol (trade name: R2105, manufactured by KURARAY CO., LTD.) and 13.5 g of an encapsulating liquid for an ultraviolet filter was prepared. The mixture was further mixed with 17 g of an aqueous 50% by mass 2-(3-tert-butyl-5-methyl-2-hydroxyphenyl)-5-chlorobenzotriazole solution, 65 g of a 20% by mass colloidal silica dispersion (trade name: SNOWTEX 0, manufactured by NISSAN CHEMICAL INDUSTRIES, LTD.), 2.5 g of polyoxyethylene alkyl ether phosphate (trade name: NEOSCORE CM57, manufactured by TOHO Chemical Industry Co., Ltd.), and 2.5 g of polyethylene glycol dodecyl ether (trade name: EMULGEN 109P, manufactured by Kao Corporation), so that a coating liquid for an ultraviolet-absorbing film was obtained.

The resulting coating liquid was then applied onto the barrier layer of the element with a wire bar. The coating was then dried at 120° C. for 5 minutes to form an about 1 μm thick ultraviolet-absorbing film was formed.

A reflective liquid crystal element was obtained by the process described above.

Evaluation of Display Performance

The resulting reflective liquid crystal element was evaluated in the same manner as in Example 1. As a result, the contrast ratio was 7.0, therefore, it was confirmed that the resulting reflective liquid crystal element had high contrast ratio.

Evaluation of Response Speed

The response speed of the resulting reflective liquid crystal element was 120 ms as measured by the same method as in Example 1.

Evaluation of Light Resistance

The light resistance was evaluated. The reflective liquid crystal element was exposed to a Xe lamp (150,000 lux) for 480 hours. As a result, there was no change in the electrical properties of the reflective liquid crystal element. Thus, the reflective liquid crystal element of Example 4 was found to have excellent light resistance.

Evaluation of Heat Resistance

The heat resistance was evaluated. The reflective liquid crystal element was stored in an oven kept at 85° C. for one week, and then the electrical properties were evaluated. As a result, there was no change in the electrical properties of the reflective liquid crystal element. Thus, the reflective liquid crystal element of Example 4 was found to have excellent heat resistance.

Evaluation of Resistance to Heat and Humidity

The resistance to heat and humidity was evaluated. The reflective liquid crystal element was stored in a thermostatic oven kept at a humidity of 80% and a temperature of 60° C. for one week, and then the electrical properties were evaluated. As a result, there was no change in the electrical properties of the reflective liquid crystal element. Thus, the reflective liquid crystal element of Example 4 was found to have excellent resistance to heat and humidity.

The foregoing description of the embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

All publications, patent applications, and technical standards mentioned in this specification are herein incorporated by reference to the same extent as if each individual publication, patent application, or technical standard was specifically and individually indicated to be incorporated by reference.

What is claimed is:

1. A liquid crystal composition, comprising:
at least one nematic liquid crystal,
at least two chiral reagents; and
at least one dichroic dye represented by the following Formula (1): 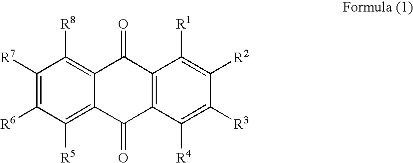
wherein R¹, R², R³, R⁴, R⁵, R⁶, R⁷ and R⁸ each independently represent a hydrogen atom or a substituent, and wherein at least one of R¹, R², R³, R⁴, R⁵, R⁶, R⁷ and R⁸ represents a substituent represented by -(Het)ₘ-{(B¹)ₚ-(Q¹)_{q}-(B²)ᵣ}ₙ—C¹, wherein: Het represents an oxygen atom, a sulfur atom or NR, wherein R represents a hydrogen atom, an alkyl group, an aryl group, or a heteroaryl group; B¹ and B² each independently represent an arylene group, a heteroarylene group or a divalent cyclic aliphatic hydrocarbon group; Q¹ represents a divalent linking group; C¹ represents an alkyl group, a cycloalkyl group, an alkoxy group, an acyl group, an alkoxycarbonyl group, or an acyloxy group; m represents 0 or 1; p, q and r each represent an integer from 0 to 5; n represents an integer from 1 to 3; (p+r)xn is from 3 to 10; when p, q and r are each 2 or more, two or more occurrences of B¹, Q¹ or B² represent the same or different species; and when n is 2 or more, two or more occurrences of {(B¹)ₚ-(Q¹)_{q}-(B²)ᵣ} represent the same or different species.

2. The liquid crystal composition according to claim 1, wherein at least one of R¹, R⁴, R⁵, and R⁸ represents the substituent represented by -(Het)ₘ-{(B¹)ₚ-(Q¹)_{q}-(B²)ᵣ}ₙ—C¹.

3. The liquid crystal composition according to claim 1, wherein in Formula (1), at least R¹ represents the substituent represented by -(Het)ₘ-{(B1)ₚ-(Q¹)_{q}-(B²)ᵣ}ₙ—C¹.

4. The liquid crystal composition according to claim 1, wherein the dichroic dye represented by Formula (1) has two or three substituents respectively represented by -(Het)ₘ-{(B¹)ₚ-(Q¹)_{q}-(B²)ᵣ}ₙ—C¹.

5. The liquid crystal composition according to claim 1, wherein the -{(B¹)ₚ-(Q¹)_{q}-(B²)ᵣ}ₙ—C¹ has a structure represented by Formula (a-1) or Formula (a-2): 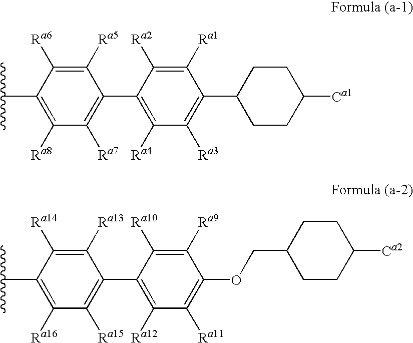
wherein R^{a1} to R^{a16} each independently represent a hydrogen atom or a substituent, and C^{a1} and C^{a2} each independently represent an alkyl group.

6. The liquid crystal composition according to claim 5, wherein in Formulae (a-1) and (a-2), C^{a1} and C^{a2} each represent a straight-chain alkyl group having from 3 to 10 carbon atoms.

7. The liquid crystal composition according to claim 1, wherein the two or more chiral reagents respectively have different main structures.

8. The liquid crystal composition according to claim 1, wherein a combination of the two or more chiral reagents includes one of the following combinations:
(1) an aromatic ester derivatives and a cholesterol derivatives,
(2) an aromatic ether derivatives and a cholesterol derivatives,
(3) an aliphatic ester derivatives and a cholesterol derivatives,
(4) an aliphatic ether derivatives and a cholesterol derivatives,
(5) a cyclic aliphatic derivatives and a cholesterol derivatives, and
(6) an aromatic ester derivatives and a cyclic aliphatic derivatives.

9. The liquid crystal composition according to claim 1, wherein at least one of the two or more chiral reagents includes a cholesterol structure-containing chiral reagent.

10. The liquid crystal composition according to claim 9, wherein a content of the cholesterol structure-containing chiral reagent is from 10 to 90% by mass, with respect to a total content of the tow or more chiral reagents.

11. The liquid crystal composition according to claim 1, wherein at least one of the two or more chiral reagents is a chiral reagent represented by Formula (2): 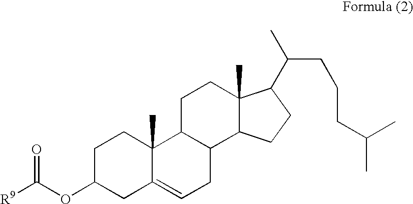
wherein R⁹ represents an alkyl group.

12. The liquid crystal composition according to claim 11, wherein in Formula (2), R⁹ represents an alkyl group having a liquid crystalline group linked through an ester bond.

13. The liquid crystal composition according to claim 1, wherein a transition temperature (Tᵢₛₒ) at which the at least one nematic liquid crystal changes from a liquid crystal state to an isotropic state is raised by from 0.1 to 20° C. due to the addition of the chiral reagents.

14. The liquid crystal composition according to claim 1, wherein the at least one nematic liquid crystal containing the chiral reagents has a chiral pitch of 1.0 μm to 10 μm.

15. The liquid crystal composition according to claim 1, wherein the at least one nematic liquid crystal is a fluorine-containing liquid crystal.

16. A reflective display element, comprising:
a pair of electrodes at least one of which is a transparent electrode; and
a liquid crystal layer placed between the pair of electrodes and containing the liquid crystal composition of claim 1.

17. The reflective display element according to claim 16, wherein the ratio (P/G) of the chiral pitch (P) of the liquid crystal composition to the thickness (G) of the liquid crystal layer is from 15% to 500%.

18. The reflective display element according to claim 16, further comprising a white scattering layer.

19. The reflective display element according to claim 16, wherein it is an active driving element.
